(19) United States
(12) Patent Application Publication
(10) Pub. No.: US 2024/0405899 A1
(43) Pub. Date: Dec. 5, 2024

(54) ADAPTIVE SIGNAL STRENGTH THRESHOLDS FOR REDUCED CAPABILITY RADIO PROCEDURES

(71) Applicant: Telefonaktiebolaget LM Ericsson (publ), Stockholm (SE)

(72) Inventors: Muhammad Ali KAZMI, Sundbyberg (SE); Santhan THANGARASA, Vällingby (SE); Kazuyoshi UESAKA, Kawasaki Kanagawa (JP); Emre YAVUZ, Stockholm (SE); Zhixun TANG, Beijing (CN); Andreas HÖGLUND, Solna (SE)

(21) Appl. No.: 18/701,450

(22) PCT Filed: Oct. 20, 2022
(86) PCT No.: PCT/SE2022/050950

§ 371 Date: Apr. 15, 2024

(30) Foreign Application Priority Data
Oct. 21, 2021 (WO) PCT/CN2021/125329

(51) Int. Cl. H04B 17/318; H04W 74/0833

(52) U.S. Cl. CPC H04B 17/318; H04W 74/0833

(57) ABSTRACT

The present disclosure relates to adaptive signal strength thresholds and other parameters to support reduced capability UEs. In embodiments of the present invention, a UE receives a first signal strength threshold value from a network node, and, from the received first signal strength threshold value, the UE derives a second signal strength threshold value associated with a receiver configuration supported by the UE for performing a radio procedure. The derived second signal strength threshold value is used when performing the radio procedure.

### TECHNICAL FIELD

The present disclosure relates generally to radio procedures for reduced capability (RedCap) user equipment (UE) and, more particularly to adaptive signal strength thresholds for radio procedures performed by RedCap UE.

### BACKGROUND

Procedures and requirements to support reduced capability (RedCap) UEs, which entails characteristics like low complexity and low power consumption, are being specified in Rel-17. The complexity reduction features for a RedCap UE include a reduced maximum UE bandwidth, a reduced minimum number of receive (Rx) branches, a maximum number of downlink (DL) Multiple Input, Multiple Output (MIMO) layers, a relaxed maximum modulation order, and duplex operation.

In the New Radio (NR) standard, the network node signals one or more signal strength thresholds to the UE for performing one or more radio procedures. Examples of signal strength measurements are path loss, Reference Signal Received Power (RSRP), etc. The signal strength (e.g., RSRP) is measured by the UE on a configured reference signal (RS). Examples of RSs are the synchronization signal block (SSB), channel state information reference signal (CSI-RS), positioning reference signal (PRS), etc. A signal strength threshold is associated with the same type of RS on which the UE performs the signal strength measurement. Examples of signal strength thresholds currently used or being specified in NR include signal strength thresholds for the selection of a reference signal for 4-step and 2-step random access, signal strength for selection between normal uplink (UL) carrier (NUL) and supplementary UL carrier (SUL), signal strength for selection between 4-step and 2-step RA, signal strength for selection between small data transmission (SDT) and legacy (Non-SDT) transmissions, and signal strength for selection of resources for SDT.

In NR, a RedCap UE may support 1 Rx branch or 2 Rx branches. For convenience, a UE configured with 1 Rx branch is referred to as a 1 Rx UE or 1 Rx receiver. A UE configured with 2 Rx branches is referred to as a 2 Rx UE or 2 Rx receiver. At any given time, a cell may serve a mixture of UEs with different receiver configurations. For example, a cell may serve one or more RedCap UEs supporting 1 Rx as well as normal UEs supporting 2 Rx. The RedCap UE will operate in Radio Resource Control (RRC) idle/inactive as well as in RRC connected state. Furthermore, RedCap Rx capability depends on frequency band. The same RedCap UE may support several frequency bands with different numbers of Rx branches. For example, the same RedCap UE may support 1 Rx for lower frequency bands (e.g., up to 2 GigaHertz (GHz)) and 2 Rx for higher bands (e.g., above 2 GHZ). The performance of signal measurements (e.g., RSRP) performed by the UE using 1 Rx and 2 Rx configurations may vary significantly. For example, measurements (e.g., RSRP) performed using 1 Rx branch are subject to more bias (e.g., ±6.5 dB error) compared to measurements done using 2 Rx (e.g., ±4.5 dB error) assuming the same measurement samples (e.g., 3 SSBs). Using the existing signaling procedures for performing radio procedures based on the signal strength measurement may significantly degrade the network coverage resulting in coverage holes. Therefore, new signaling procedures are needed to enhance the UE performance of radio procedures that rely on the signal strength measurement.

### SUMMARY

The present disclosure relates to methods for signaling and configuring signal strength thresholds and other parameters for various radio procedures performed by a UE. In embodiments of the present invention, the signal strength thresholds signaled to and/or used by the UE to perform a radio procedure depend on a receiver configuration of the UE, e.g., number of Rx branches. The UE can be configured to use different signal strength thresholds for the same radio procedure depending on the receiver configuration of the UE. As an example, a RedCap UE may support two receiver configurations: a 1 Rx configuration and a 2 Rx configuration. In another example, a RedCap UE may support two receiver configurations: a first receiver configuration which can mitigate interference and a second receiver configuration which cannot mitigate interference. The first receiver configuration may further comprise 1 Rx or 2 Rx configurations. The interference mitigation by the first receiver configuration is realized by performing one or more of: suppression, cancellation, minimization or elimination of the interference received by the UE from signals in one or more interfering cells. The interfering cell can be the serving cell of the UE, or it can be a neighbor cell of the UE. The network node can provide the UE with a first signal strength threshold for the 1 Rx configuration and a second, and different, signal strength threshold for the 2 Rx configuration. The network node can provide the UE with a third signal strength threshold for the first receiver configuration and a fourth, and different, signal strength threshold for the second receiver configuration.

A first aspect of the disclosure comprises methods implemented by a UE. The method comprises receiving a first signal strength threshold value from a network node and deriving a second signal strength threshold value associated with a receiver configuration supported by the UE for performing a radio procedure. The second signal strength threshold value is derived from the received first signal strength threshold value. The method further comprises performing the radio procedure using the second signal strength threshold value.

A second aspect of the disclosure comprises a UE. The UE is configured to receive a first signal strength threshold value from a network node and derive a second signal strength threshold value associated with a receiver configuration supported by the UE for performing a radio procedure. The second signal strength threshold value is derived from the received first signal strength threshold value. The UE is further configured to perform the radio procedure using the second signal strength threshold value.

A third aspect of the disclosure comprises a UE including communication circuitry for communicating with a network node and processing circuitry. The processing circuitry is configured to receive a first signal strength threshold value from a network node and derive a second signal strength threshold value associated with a receiver configuration supported by the UE for performing a radio procedure. The second signal strength threshold value is derived from the received first signal strength threshold value. The processing circuitry is further configured to perform the radio procedure using the second signal strength threshold value.

A fourth aspect of the disclosure comprises computer programs comprising executable instructions that, when executed by a processing circuit in a UE in a wireless communication network, causes the UE to perform any one of the methods according to the first aspect.

A fifth aspect of the disclosure comprises a carrier containing a computer program according to the fourth aspect, wherein the carrier is one of an electronic signal, optical signal, radio signal, or computer readable storage medium.

A sixth aspect of the disclosure comprises methods implemented by a network node. The method comprises determining a first receiver configuration supported by a UE for performing a radio procedure, and sending, to the UE, a first signal strength threshold value associated with a second receiver configuration for the UE to derive, from the first signal strength threshold value, a second signal strength threshold value associated with the first receiver configuration.

A seventh aspect of the disclosure comprises a network node. The network node is configured to determine a first receiver configuration supported by a UE for performing a radio procedure, and send, to the UE, a first signal strength threshold value associated with a second receiver configuration for the UE to derive, from the first signal strength threshold value, a second signal strength threshold value associated with the first receiver configuration.

An eighth aspect of the disclosure comprises a network node including communication circuitry for communicating with a UE and processing circuitry. The processing circuitry is configured to determine a first receiver configuration supported by the UE for performing a radio procedure, and send, to the UE, a first signal strength threshold value associated with a second receiver configuration for the UE to derive, from the first signal strength threshold value, a second signal strength threshold value associated with the first receiver configuration.

A ninth aspect of the disclosure comprises computer programs comprising executable instructions that, when executed by a processing circuit in a network node in a wireless communication network, causes the network node to perform any one of the methods according to the sixth aspect.

A tenth aspect of the disclosure comprises a carrier containing a computer program according to the ninth aspect, wherein the carrier is one of an electronic signal, optical signal, radio signal, or computer readable storage medium.

### BRIEF DESCRIPTION OF THE DRAWINGS

FIG. 1 illustrates a communication network supporting RedCap UEs.

FIG. 2 illustrates a first exemplary use case scenario for adaptive signal strength thresholds.

FIG. 3 illustrates a second exemplary use case scenario for adaptive signal strength thresholds.

FIG. 4 illustrates a third exemplary use case scenario for adaptive signal strength thresholds.

FIG. 5 illustrates signal strength thresholds for selecting between 2-step and 4-step random access.

FIG. 6 illustrates an exemplary method implemented by a UE configured to use adaptive signal strength thresholds.

FIG. 7 illustrates an exemplary method implemented by a network node configured to provide adaptive signal strength thresholds to a UE.

FIG. 8 illustrates an exemplary method implemented by a network node configured to provide adaptive signal strength thresholds to a UE.

FIG. 9 illustrates an exemplary method implemented by a network node configured to provide adaptive signal strength thresholds to a UE.

FIG. 10 illustrates an exemplary method implemented by a UE.

FIG. 11 illustrates an exemplary method implemented by a network node.

FIG. 12 illustrates an exemplary UE configured to use adaptive signal strength thresholds.

FIG. 13 illustrates an exemplary method implemented by a network node configured to provide adaptive signal strength thresholds to a UE.

FIG. 14 illustrates an exemplary method implemented by a network node configured to provide adaptive signal strength thresholds to a UE.

FIG. 15 illustrates an exemplary method implemented by a network node configured to provide adaptive signal strength thresholds to a UE.

FIG. 16 illustrates an exemplary UE configured to use adaptive signal strength thresholds.

FIG. 17 illustrates an exemplary method implemented by a network node configured to provide adaptive signal strength thresholds to a UE.

FIG. 18 is a schematic block diagram illustrating an example wireless network, according to particular embodiments of the present disclosure.

FIG. 19 is a schematic block diagram illustrating an example of a user equipment, according to particular embodiments of the present disclosure.

FIG. 20 is a schematic block diagram illustrating an example of a virtualization environment, according to particular embodiments of the present disclosure.

FIG. 21 is a schematic illustrating an example telecommunication network, according to particular embodiments of the present disclosure.

FIG. 22 is a schematic block diagram illustrating an example communication system, according to particular embodiments of the present disclosure.

FIGS. 23-26 are flow diagrams, each of which illustrates an example method implemented in a communication system, according to particular embodiments of the present disclosure.

### DETAILED DESCRIPTION

Referring now to the drawings, an exemplary embodiment of the disclosure will be described in the context of a Fifth Generation (5G)/New Radio (NR) wireless communication network. Those skilled in the art will appreciate that the methods and apparatus herein described are not limited to use in 5G networks but may also be used in wireless communication networks 100 operating according to other radio access technologies (RATs). Examples of other RATs include Universal Mobile Telecommunications System (UMTS) Terrestrial Radio Access (UTRA), Evolved (UMTS) Terrestrial Radio Access (E-UTRA), Narrowband Internet-of-Things (NB-IoT), Wireless Fidelity (WiFi), BLUETOOTH, and Long Term Evolution (LTE) to name a few.

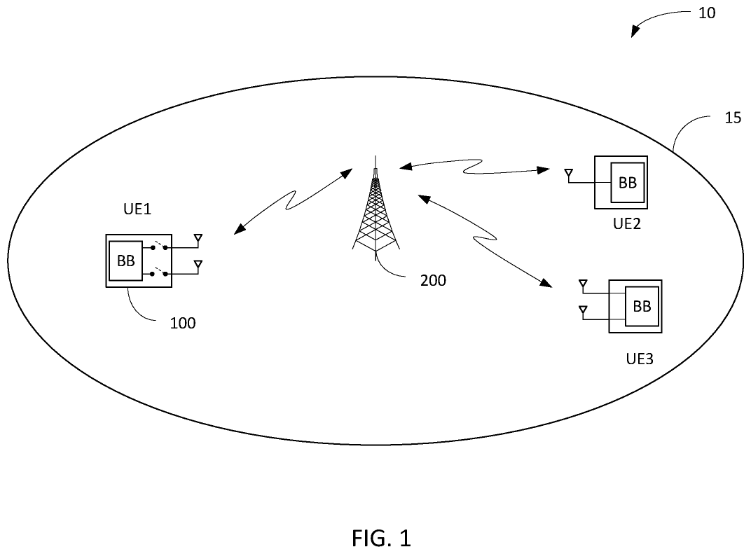

FIG. 1 illustrates a radio access network (RAN) 10 according to the 5G standard developed by Third Generation Partnership Project (3GPP). The RAN 10 includes one or more radio network nodes 200, also referred to as access nodes, providing service to one or more UEs 100 within a cell 15 served by the radio network node 200. The radio network nodes 200 provide the UEs 100 in cell 15 with access to the 5G Core Network (5GC) (not shown). The radio network nodes in 5G are commonly known as 5G NodeBs (gNBs). In Fourth Generation (4G) networks, also known as Long Term Evolution (LTE) networks, the radio network nodes 200 are referred to as Evolved NodeBs (eNBs). An eNB that communicates with the 5GC is known as a Next Generation eNB (ng-eNB).

The UEs 100 may comprise any type of equipment capable of communicating with the radio network nodes 200 over a wireless communication channel. For example, the UEs 100 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 10.

In the embodiment shown in FIG. 1, three UEs are shown and denoted as UE1-UE3 respectively. UE1 is configurable to use one or two Rx branches. UE2 is configured to use 1 Rx branch. UE3 is configured to use 2 Rx branches. As will be hereinafter described in more detail, different signal strength thresholds for the same radio procedure can be defined for UEs with different receiver configurations.

In this disclosure, the term “node” refers to a network node or a user equipment (UE). A network node can be a core network node or RAN node, i.e., radio network node.

The term “signal” or “radio signal” in this disclosure refers to any physical signal or physical channel. A signal may comprise a control signal, reference signal (RS) or data signal. Examples of downlink (DL) reference signals (RS) include the primary synchronization signal (PSS), secondary synchronization signal (SSS), channel state information reference signal (CSI-RS), demodulation reference signals (DMRS) in the synchronization signal block (SSB), discovery reference signals (DRS), cell-specific reference signal (CRS), positioning reference signals (PRS), etc. Examples of UL physical signals are reference signals such as sounding reference signals (SRS), DMRS, etc. RSs may be periodic.

The term physical channel refers to any channel carrying higher layer information e.g., data, control, etc. Examples of physical channels are Physical Broadcast Channel (PBCH), Physical Downlink Control Channel (PDCCH), Physical Downlink Shared Channel (PDSCH), Physical Uplink Control Channel (PUCCH), Physical Uplink Shared Channel (PUSCH), Narrowband PBCH (NPBCH), Narrowband PDCCH (NPDCCH), Narrowband PDSCH (NPDSCH), Narrowband PUCCH (NPUCCH), Narrowband PUSCH (NPUSCH), short PBCH (sPBCH), short PDCCH (sPDCCH), short PDSCH (sPDSCH), short PUCCH (sPUCCH), short PUSCH (sPUSCH), MTC PBCH (MPBCH), MTC PDCCH (MPDCCH), MTC PDSCH (MPDSCH), MTC PUCCH (MPUCCH), MTC PUSCH (MPUSCH).

In NR, a RS occasion carrying one or more RSs may occur with certain periodicity, e.g., 20 ms, 40 ms. The RS may also be aperiodic. As an example, a synchronization signal is periodically transmitted on the downlink from each NR cell. Each SSB in NR carries the NR-PSS, NR-SSS and NR-PBCH in 4 successive symbols. One or multiple SSBs are transmitted in one SSB burst which is repeated with certain periodicity e.g., 5 ms, 10 ms, 20 ms, 40 ms, 80 ms and 160 ms. The SSB enables a UE 100 to find a cell when entering a system, as well as to find new cells when moving within the system.

The UE 100 is configured with information about SSBs in cells of certain carrier frequency by one or more SSB measurement timing configuration (SMTC) configurations. The SMTC configuration comprises parameters such as SMTC periodicity, SMTC occasion length in time or duration, SMTC time offset with respect to a reference time (e.g., serving cell's SFN) etc. Therefore, a SMTC occasion may also occur with certain periodicity, e.g., 5 ms, 10 ms, 20 ms, 40 ms, 80 ms and 160 ms.

The term time resource used herein may correspond to any type of physical resource or radio resource expressed in terms of length of time. Examples of time resources are symbol, sub-slot, mini-slot, time slot, subframe, radio frame, transmission time interval (TTI), interleaving time, frame, system frame number (SFN) cycle, hyper-SFN cycle, etc.

The present disclosure relates generally to the configuration and signaling of signal strength thresholds and other parameters (e.g., timers and counters) used by UEs to perform or carry out certain radio procedures, such as SSB selection, 2-step or 4-step random access, etc. For illustration, exemplary embodiments described herein focus on the configuration of a signal strength threshold for various radio procedures. Those skilled in the art will appreciate that the techniques and principles herein described can be applied to timers, counters and other parameters used to configure radio procedures for a UE.

In the New Radio (NR) standard, the network node 200 signals one or more signal strength thresholds to the UE 100 for performing one or more radio procedures. In the course of performing a radio procedure, the UE 100 may perform a signal strength measurement and compare the signal strength measurement to the configured signal strength threshold to determine an action to take. The signal strength measurements may be performed on reference signals transmitted by a cell, such as the SSB, CSI-RS, PRS, etc. Examples of signal strength measurements are path loss, Reference Signal Received Power (RSRP), etc. The signal strength (e.g., RSRP) is measured by the UE 100 on a configured reference signal (RS).

A signal strength threshold is associated with the same type of RS on which the UE 100 performs the signal strength measurement. The signal strength threshold may be used, for example, to select a reference signal for 4-step and 2-step random access, to choose between a normal uplink (UL) carrier (NUL) and a supplementary UL carrier (SUL), to choose between 4-step and 2-step RA, to choose between small data transmission (SDT) and legacy (Non-SDT) transmissions, and to select resources for SDT. Examples of signal strength thresholds currently used or being specified in NR include:
rsrp-ThresholdSSB: an RSRP threshold for the selection of the SSB for 4-step random access (RA) type. If the Random Access procedure is initiated for beam failure recovery, rsrp-ThresholdSSB used for the selection of the SSB within candidateBeamRSList refers to rsrp-ThresholdSSB in BeamFailureRecoveryConfig IE
rsrp-ThresholdCSI-RS: an RSRP threshold for the selection of CSI-RS for 4-step RA type. If the Random Access procedure is initiated for beam failure recovery, rsrp-ThresholdCSI-RS is equal to rsrp-ThresholdSSB in Beam FailureRecoveryConfig IE
msgA-RSRP-ThresholdSSB: an RSRP threshold for the selection of the SSB for 2-step RA type
rsrp-ThresholdSSB-SUL: an RSRP threshold for the selection between the NUL carrier and the SUL carrier
msgA-RSRP-Threshold: an RSRP threshold for selection between 2-step RA type and 4-step RA type when both 2-step and 4-step RA type Random Access Resources are configured in the UL BWP.
RSRP-threshold-STD: an RSRP threshold for selection between transmission using small data transmission (STD) and legacy (non-STD) mechanisms.
RSRP-thresholdCG: an RSRP threshold for the selection of the SSB for CG-SDT resources for SDT.

A typical use case for signal strength thresholds is the random access (RA) procedure. Two types of random access (RA) procedures are specified in NR: 4-step RA and 2-step RA.

In 4-step RA, the UE 100 randomly selects a RA preamble corresponding to a RS (e.g., SSB, CSI-RS) based on its RSRP (e.g., SSB whose RSRP is above RSRP threshold (e.g., rsrp-ThresholdSSB)), and transmits the preamble on the PRACH occasion which maps to the selected RS resource (SSB). The UE 100 receives a Timing Advance (TA) and allocated UL resources from the network in Msg2. In Msg3 the UE 100 transmits its identifier (ID) (e.g., UE ID, Cell Radio Network Temporary Identifier (C-RNTI)). In Msg4, the UE 100 performs the contention resolution by acknowledging the UE identifier.

In the 2-step RA, the preamble and a message corresponding to Msg3 (msgA PUSCH) in the 4-step RA can, depending on configuration, are transmitted in two subsequent slots. The RA preamble is selected based on RS (e.g., SSB), whose RSRP is above RSRP threshold (e.g., msgA-RSRP-ThresholdSSB). The msgA PUSCH is sent on a resource dedicated to the specific preamble. The UE 100 receives msgB which may contain a grant, a TA command, etc. The 2-step RA procedure compared to 4-step RA therefore leads to much shorter transmission delay.

When both 4-step RA and 2-step RA are configured, the UE 100 selects 2-step RA if the RSRP of the downlink pathloss reference (e.g., configured RS such as SSB) is above RSRP threshold (e.g., msgA-RSRP-Threshold); otherwise the UE 100 selects 4-step RA.

Another use case for signal strength thresholds is small data transmissions (SDTs). In NR, a UE 100 in Radio Resource Control (RRC) inactive (RRC_INACTIVE) state with infrequent periodic and/or aperiodic data can transmit small amount of data, which is called as small data transmission. Small data transmission (SDT) is therefore a procedure to transmit UL data by the UE 100 in RRC_INACTIVE state. SDT is performed with either random access (using RACH-based SDT) or a configured grant (CG) (using Configured Grant (CG)-based SDT). If the UE 100 uses 4-step RA for SDT procedure, the UE 100 transmits the UL data in the Msg3. If the UE 100 uses 2-step RA for SDT procedure, the UE 100 transmits UL data in the MsgA.

CG PUSCH resources are the PUSCH resources configured in advance for the UE 100. When there is uplink data available in UE buffer, it can immediately start uplink transmission using the pre-configured PUSCH resources without waiting for an UL grant from the network node 200 (e.g., gNB), thus reducing latency. NR supports CG type 1 PUSCH transmission and CG type 2 PUSCH transmission. For both types, the PUSCH resources (time and frequency allocation, periodicity, etc.) are preconfigured via dedicated RRC signaling. The CG type 1 PUSCH transmission is activated/deactivated by RRC signaling, while the CG type 2 PUSCH transmission is activated/deactivated by an UL grant using downlink control information (DCI) signaling. An association between CG resources and SSBs is configured for CG-based SDT.

Upon arrival of the data in the UE 100 buffer, the UE 100 may decide whether to use SDT mechanism or legacy mechanism (e.g., by sending RRCResumeRequest) to transmit the data based on comparison between the RSRP of a configured RS and RSRP threshold (e.g., RSRP-threshold-STD). For example, the SDT mechanism is selected if the RSRP is above RSRP-threshold-STD, otherwise the legacy mechanism is used. The UE 100 selects the CG-SDT resource for transmission based on comparison between the RSRP of configured RS and RSRP threshold. For example, CG-SDT resources associated with or corresponding a RS (e.g., SSB) whose RSRP is above RSRP threshold (e.g., RSRP-thresholdCG) are selected by the UE 100 for data transmission.

3GPP is currently developing procedures and requirements to support reduced capability (RedCap) UEs, which entails characteristics like low complexity and low power consumption. The complexity reduction features for a RedCap UE 100 include a reduced maximum UE 100 bandwidth, a reduced minimum number of receive (Rx) branches, a maximum number of downlink (DL) Multiple Input, Multiple Output (MIMO) layers, a relaxed maximum modulation order, and duplex operation.

The maximum bandwidth of a Frequency Range 1 (FR1) RedCap UE 100 during and after initial access is 20 MHz. The maximum bandwidth of a Frequency Range 2 (FR2) RedCap UE 100 during and after initial access is 100 MHz.

For frequency bands where a legacy NR UE 100 is required to be equipped with a minimum of 2 Rx antenna ports, the minimum number of Rx branches supported by specification for a RedCap UE 100 is 1. The specification also supports 2 Rx branches for a RedCap UE 100 in these bands. For frequency bands where a legacy NR UE 100 (other than 2-Rx vehicular UE) is required to be equipped with a minimum of 4 Rx antenna ports, the minimum number of Rx branches supported by specification for a RedCap UE 100 is 1. The specification also supports 2 Rx branches for a RedCap UE 100 in these bands. For a RedCap UE 100 with 1 Rx branch, 1 DL MIMO layer is supported. For a RedCap UE 100 with 2 Rx branches, 2 DL MIMO layers are supported.

Support of 256 Quadrature Amplitude Modulation (QAM) in DL is optional (instead of mandatory) for an FR1 RedCap UE. No other relaxations of maximum modulation order are specified for a RedCap UE.

A RedCap UE 100 may implement frequency division duplexing (FDD) half-duplex FDD (HD-FDD) and time division duplexing (TDD) in FR1 and TDD in FR2.

As noted above, a RedCap UE 100 may use fewer Rx branches than a baseline UE. In scenarios where a baseline UE 100 uses 2 Rx branches, a RedCap UE 100 may use 1 Rx branch or 2 Rx branches, referred to respectively as the 1 Rx and 2 Rx configurations. Therefore, in the same cell there can be RedCap UEs supporting 1 Rx as well as normal UEs supporting 2 Rx. The RedCap UE 100 will operate in RRC idle/inactive as well as in RRC connected state. Furthermore, RedCap Rx capability depends on frequency band. The same RedCap UE 100 may support several frequency bands with different number of Rx branches. For example, the same RedCap UE 100 may support 1 Rx for lower frequency bands (e.g., up to 2 GHZ) and 2 Rx for higher bands (e.g., above 2 GHZ). The performance of signal measurements (e.g., RSRP), by the UE 100 using 1 Rx and 2 Rx may vary significantly. For example, the measurements (e.g., RSRP) performed using 1 Rx are subject to more bias (e.g., 6.5 dB error) compared to measurements done using 2 Rx (e.g., ±4.5 dB error) assuming the same measurement samples (e.g., 3 SSBs). Using the existing principles for performing radio procedures based on the signal strength measurement may significantly degrade the network coverage e.g., coverage holes. Therefore, new signaling procedures are needed to enhance the UE 100 performance of radio procedures which rely on the signal strength measurement.

According to one aspect of the disclosure, the network node 200 is configured to determine and signal a RSRP threshold based on the UE receiver configuration. e.g., number of Rx branches. According to this aspect, the network node 200 determines the receiver configuration of the UE 100 known or expected for performing a signal strength measurement, obtains a signal strength threshold (G) associated with the determined receiver configuration, and transmits the obtained value of G to the UE 100. In this embodiment, the network node 200 configures one signal strength threshold for a radio procedure at a time. The threshold is adaptive and depends on the known or expected UE receiver configuration. It is assumed that all UEs 100 in the same cell 15 use the same receiver configuration at any given time.

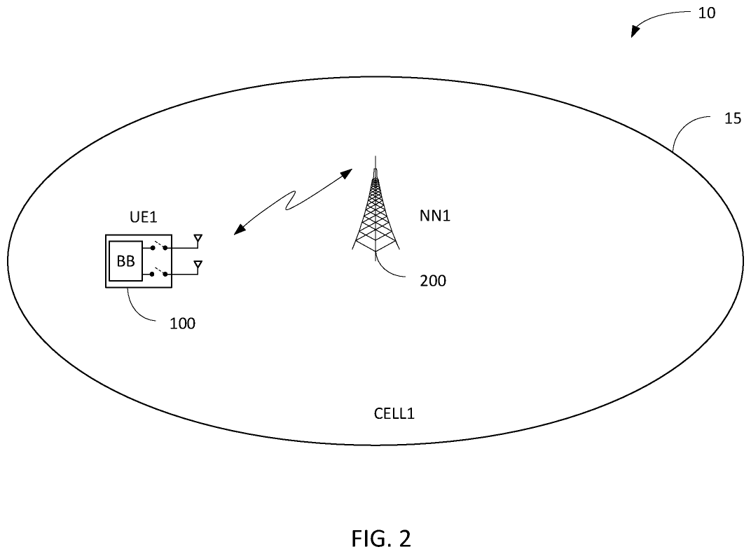

FIG. 2 illustrates one example of the first embodiment. In this example, a UE 100 served by a first cell (Cell1) is managed or served by a first radio network node 200 (NN1). The UE 100 is capable of or supports at least two different receiver configurations (e.g., 1 Rx and 2 Rx; or 1Rx and 4 Rx, or 2 Rx and 4 Rx, etc.). The UE 100 may be configured to operate using one of the receiver configurations at a time in Cell1. For example, UE 100 may switch to a different receiver configuration to improve its power consumption. In another example, the number of Rx branches is band dependent, so the same UE 100 may use 1 Rx for lower frequency bands as it has better coverage, but it may use 2 Rx for higher frequency bands. The receiver configuration may change dynamically or semi-statically, e.g., after 1 or multiple time resources. The receiver configuration is used by the UE 100 for receiving one or more signals, such as SSB, CSI-RS and/or channels e.g., PBCH, PDCCH, PDSCH etc. Cell1 may serve more than one UE 100 but in this scenario all UEs can be configured to use the same receiver configuration at any given time. The receiver configuration can be determined by the UE 100 autonomously based on one or more pre-defined rules or by the network node and signaled to the UE 100.

Examples of predefined rules to determine receiver configuration to be used in the UE 100 (e.g., in different scenarios) are described below:

In a first example of a predefined rule, the UE 100 determines or selects or applies a receiver configuration based on the frequency of Cell1. For example, the UE 100 can use a first receiver configuration (e.g., Rx1) when Cell1 operates on a first carrier frequency (F1) belonging to a frequency band (B1) in a first group of frequency bands (GOB1), and apply a second receiver configuration (e.g., Rx2) when Cell1 operates on a second carrier frequency (F2) belonging to a frequency band (B2) in a second group of frequency bands (GOB2).

In another second example of a predefined rule, the UE 100 determines or selects or applies a receiver configuration based on radio conditions. Examples of radio conditions are received signal level (Sr) at the UE 100 with respect to Cell1, received interference (Ir) at the UE 100, packet error rate (PER), etc. Examples of receive signal levels are signal strength, signal quality, etc. Examples of PER are block error rate (BLER), data BLER, transport BLER, which can be determined based on Hybrid Automatic Repeat Request (HARQ) acknowledgements/negative acknowledgements (ACK/NACK) transmitted or generated by the UE 100 for received downlink packets (e.g., data block, transport block, etc.). Examples of Ir are total receive power of all signals, etc.

In one embodiment, the receiver configuration is determined based on comparison between Sr and a received signal level threshold (Hs). In one example, the UE 100 applies a first receiver configuration (e.g., Rx1) when Sr is above Hs, otherwise the UE 100 applies first receiver configuration (e.g., Rx2).

In another embodiment, the receiver configuration is determined based on comparison between the observed PER and PER threshold (Hp). In one example the UE 100 applies Rx2 when PER is above Hp; otherwise the UE 100 applies Rx1. In one example, Rx1 and Rx2 correspond to 1 Rx and 2 Rx respectively.

In a third example of a predefined rule, the UE 100 supporting at least two receiver configurations determines the receiver configuration based on the available UE battery power level. For example, the receiver configuration is determined based on comparison between the remaining UE battery power and battery power threshold (Hb). In one example, the UE 100 applies first receiver configuration (e.g., Rx1) when the UE battery power is above Hp, otherwise the UE 100 applies a second receiver configuration (e.g., Rx2). In one example, Rx1 and Rx2 correspond to 1 Rx and 2 Rx respectively.

In a fourth example of a predefined rule, the UE 100 determines the receiver configuration based on a combination of Example 2 and 3 above. That is, a UE 100 could choose to use a receiver configuration providing lower performance, e.g., 1 Rx branch instead of 2 Rx branches, to lower the UE 100 energy consumption when in good coverage based on the rationale that 1 Rx branch gives sufficient performance in good coverage but with a lower receiver power. In this case, the UE 100 can configure the receiver with 2 Rx branches in bad coverage (cell-edge) to provide improved link performance. To maintain network control, the UE 100 can be configured to obey certain control parameters signaled from access node to the UE, e.g., in system information (SI). For example, an RSRP-threshold above which UEs are only allowed to use a less capable receiver, e.g., 1 Rx branch, than they are capable of.

According to a method implemented by the network node 200, the network node 200 obtains information about the current or expected receiver configuration for a UE 100 served by Cell1. Based on the current or expected receiver configuration, the network node 200 determines at least one signal strength threshold (G) and transmits information about the determined value of G to the UE 100. The value of G may be transmitted to the UE 100 in broadcast message or in a UE-specific (e.g., dedicated) message via downlink control information (DCI), Medium Access Control (MAC) Control Element (MAC-CE) or RRC signaling. The determined value of G may be obtained or selected or determined from a range of possible values Gr={g1, g2, g3, . . . , gk}. Gr may be pre-defined or configured by the network node 200. The value of G may further depend on one or more of cell size, type of radio procedures for which the UE 100 uses G, UE 100 physical or geographical location in Cell1, etc. The UE 100 uses G for performing one or more radio procedures. For example, the UE 100 can use G to determine or select a RS for random access transmission, etc.

The network node 200 can obtain the current or expected receiver configuration for a radio procedure performed by the UE 100 in Cell1 based on one or more pre-defined rules as described above, by receiving an indication of the receiver configuration from the UE 100, by selecting the receiver configuration and signaling the selected receiver configuration to the UE 100, or some companion thereof. As an example of the first case, the network node 200 can determine the expected UE 100 receiver configuration based on the frequency band of the carrier on which Cell1 operates, radio conditions, UE battery power, etc. As an example of the second case, the network node 200 can receive an indication from the UE 100 of the current or expected receiver configuration for a radio procedure via uplink (UL) physical channel, MAC or RRC signaling. In this case, the UE 100 adapts or selects or decides the receiver configuration and informs the network node 200. As an example of the third case, the network node 200 can determine the receiver configuration for the UE 100 based on a target or required data rate to be achieved by the UE 100. For example, the network node 200 can select a first receiver configuration (e.g., 1 Rx) if target data rate is below a data rate threshold (Hd), otherwise it selects a second receiver configuration (e.g., 2 Rx). In this case, the network node 200 signals the receiver configuration to the UE, i.e., configures the UE 100.

In case the network node 200 cannot obtain the information about the receiver configuration, it may assume that a default receiver configuration is used, e.g., 2 Rx.

The network node 200 determines the signal strength threshold (G) based on a relation or mapping between receiver configurations and one or more thresholds. The relation or mapping can be predefined by standard or configured by the network node 220. This is explained with several examples below:

A general example of the relation between n receiver configurations and corresponding thresholds is shown in Table 1. Each threshold value (e.g., G1, G2, . . . , Gn) may belong to a range of values. In one example, the value range for all thresholds may be the same. In another example, the range of values for different thresholds may be different. In another example, the range of values for a group or subset of thresholds may be the same and different for other thresholds.

TABLE 1
A general example of relation between UE 100 receiver
configurations and signal strength threshold

| Case | UE receiver configuration | Signal strength threshold (G) |
|---|---|---|
| 1 | UE first receiver | G1 |
| | configuration | |
| 2 | UE second receiver | G2 |
| | configuration | |
| . . . | . . . | . . . |
| N | UE receiver configuration n | Gn |

Table 2 illustrates a specific example of the relation between 2 different receiver configurations (1 Rx and 2 Rx) and corresponding thresholds. For example, the network node 200 may configure the UE 100 with a first threshold (G1) when the UE 100 is configured with a first receiver configuration, and with a second threshold (G2) when the UE 100 is configured with a second receiver configuration.

TABLE 2
A specific example of relation between two UE 100 receiver
configurations and signal strength threshold

| | UE receiver configuration | | |
|---|---|---|---|
| Case | UE Rx type | Number of Rx | Signal strength threshold (G) |
| 1 | First receiver | 1 | G1 |
| | configuration | | |
| 2 | Second | 2 | G2 |
| | receiver | | |
| | configuration | | |

Table 3 illustrates another specific example of the relation between 2 different receiver configurations (1 Rx and 2 Rx) and corresponding thresholds. In this example, G1 and G2 are related by a function or combination of functions. Examples of functions are sum, maximum, minimum, product, x-th percentile, etc. For example, the network node 200 may configure the UE 100 with G1 when the UE 100 is configured with a first receiver configuration, and with G1 and Δg when the UE 100 is configured with a second receiver configuration. In the latter case, the UE 100 may derive G2 based on a function relating G2 and G1 e.g., G2=f(G1, Δg). In one example G2=G1+Δg. In another example G2=G1−Δg. In this case, the UE 100 is always configured with G1 to facilitate derivation of G2 from G1 and Δg when UE 100 uses the second receiver configuration. In this example, G1 is referred to as an absolute threshold because it is not dependent on another value and G2 is referred to as a relative threshold because it is defined relative to G1.

The value Δg can, for example, be based on the difference in inaccuracy between the receiver configurations. Assuming the same measurement samples, 1 Rx is subject to more bias (e.g., ±6.5 dB error) compared to measurements performed using 2 Rx (e.g., ±4.5 dB error). In this case, Δg can. be hardcoded to be 2 dB. Therefore, G2 can be derived from G1 according to G1=G2+2 dB. In another example, Δg can be based on both the inaccuracy of measurement for each receiver configuration (e.g., ±6.5 dB error) and the measurement strength difference, such as 3 dB. In this case, G2 can be derived from G1 according to G1=G2+7 dB

TABLE 3
A specific example of relation between two UE 100 receiver
configuration and signal strength threshold

| | UE receiver configuration | | |
|---|---|---|---|
| | UE | Number | Signal strength |
| Case | Rx type | of Rx | threshold (G) |
| 1 | First receiver | 1 | G1 |
| | configuration | | |
| 2 | Second | 2 | G2 = f(G1, Dg) e.g., |
| | receiver | | G2 = G1 + Dg |
| | configuration | | |

Table 4 illustrates another specific example of the relation between 2 different receiver configurations (1 Rx and 2 Rx) and corresponding thresholds. The thresholds (G1 and G2) are expressed in terms of RSRP. In this example, G1 and G2 are −97 dBm and −100 dBm corresponding to Rx1 (1 Rx) and Rx2 (2 Rx) respectively. In one example, the UE 100 can be configured with G1=−97 dBm when it is configured with or expected to be configured with 1 Rx, and with G2=−100 dBm when it is configured with or expected to be configured with 2 Rx. In another example, the UE 100 is always configured with G1=−97 dBm, which is used when the UE 100 is configured with or expected to be configured with 1 Rx, and additionally with Δg=−3 dB when it is configured with or expected to be configured with 2 Rx. The UE 100 derives G2=−97−3=100 dBm when the UE 100 uses 2 Rx.

TABLE 4
A specific example of relation between two UE 100 receiver
configuration and RSRP threshold

| | UE receiver configuration | | |
|---|---|---|---|
| Case | UE Rx type | Number of Rx | RSRP threshold (dBm) |
| 1 | First receiver | 1 | −97 dBm |
| | configuration | | |
| 2 | Second | 2 | −100 dBm |
| | receiver | | |
| | configuration | | |

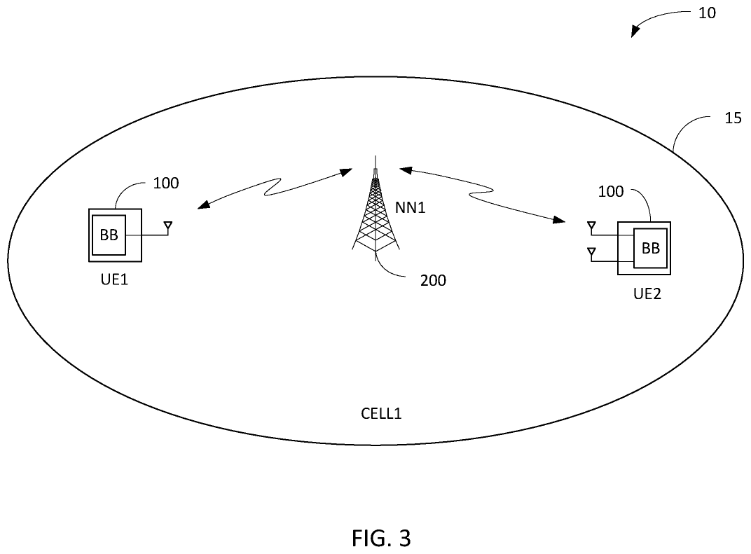

According to a second aspect of the disclosure illustrated in FIG. 3, the network node 200 is configured to determine and signal at least 2 RSRP thresholds based on configured receiver configurations in two or more UEs 100. According to this aspect, the network node 200 determines a first receiver configuration (Rx1) used by a first UE 100 (UE1) and a second receiver configuration (Rx2) used by a second UE 100 (UE2) for performing their respective signal strength measurements, obtains a first signal strength threshold (G1) associated with the determined receiver configuration of UE1, and a second signal strength threshold (G2) associated with the determined receiver configuration of UE2, and configures the obtained G1 and G2 to UE1 and UE2 respectively. The network node 200 may configure G1 and G2 in the same message or in different messages. In summary in the second embodiment the network node 200 configures at least two signal strength thresholds for radio procedures at a time. The thresholds are also adaptive and depends on the UE 100 receiver configuration configured or expected to be configured in at least 2 different UEs. It is assumed that the cell has at least 2 types of UEs using different type of receivers during at least certain overlapping time period

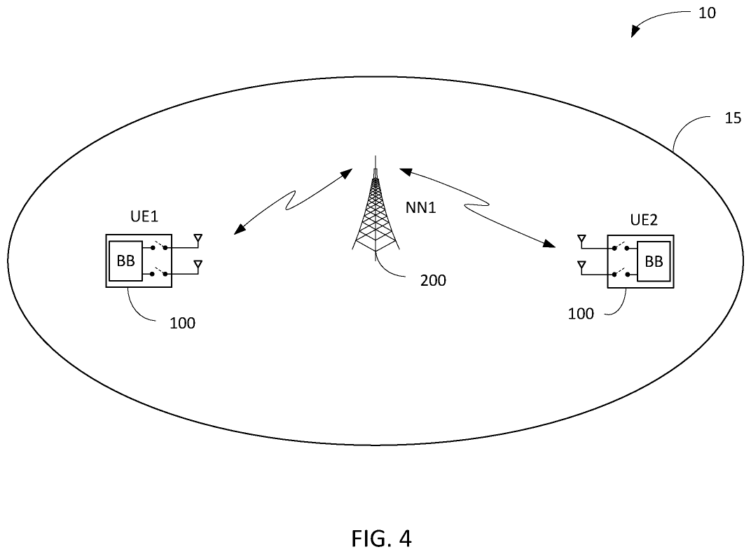

In the example shown in FIG. 4, Cell1 is serving two UEs 100, denoted UE1 and UE2, which are managed or served by the network node 200 (NN1). UE1 and UE2 may be capable of one receiver configuration or multiple receiver configurations. In one example, both UE1 and UE2 support a single receiver configuration but the receiver configurations for UE1 and UE2 are different. In another example, both UE1 and UE2 support at least 2 receiver configurations (e.g., Rx1 and Rx2). FIG. 4 illustrates an example where UE1 and UE2 both support 1 Rx and 2 Rx respectively. In another example, UE1 supports only one receiver configuration (e.g., Rx1) and UE2 supports at least two receiver configurations (e.g., Rx1 and Rx2), or vice versa. The receiver configuration for UE1 and UE2 may change dynamically or semi-statically. At any given time, UE1 and UE2 may be configured to use the same receiver configuration (RX1 or RX2) or different receiver configurations. For example, UE1 and UE2 may configured with Rx1 and Rx1 respectively or Rx2 and Rx2 respectively or Rx1 and Rx2 respectively or Rx2 and Rx1 respectively.

According to a method implemented by the network node 200, the network node 200 obtains information about the receiver configurations configured or expected to be configured in at least two UEs (UE1 and UE2) served by Cell1. If different receiver configurations are configured in UE1 and UE2, the network node 200 determines at least two signal strength thresholds (e.g., G1 and G2) based on the obtained receiver configuration information and transmits information about the determined values of G (e.g., G1 and G2) to the at least UEs 100 (e.g., UE1 and UE2). The values of G (e.g., G1 and G2) may be transmitted to the UEs 100 in a broadcast message or individually to each UE 100 in a UE-specific (e.g., dedicated) message via DCI, MAC-CE or RRC signaling. Each of the determined values of G may be selected from a range of values Gr={g1, g2, g3, . . . , gk}. Gr may be pre-defined or configured by the network node 200. Each value of G may further depend on one or more of cell size, type of radio procedures for which the UE 100 uses G, UE 100 physical or geographical location in cell1 etc. The UEs 100 use the threshold G associated with its receiver configuration to perform one or more radio procedures e.g., for determining or selecting RS for random access transmission etc.

The network node 200 can obtain the receiver configurations for UE1 and UE2 in the same manner as described above. For example, the network node 200 can obtain the expected receiver configuration for a radio procedure performed by the UE1 and UE2 in Cell1 based on one or more pre-defined rules as described above, by receiving an indication of the receiver configurations from UE1 and UE2, or by selecting the receiver configuration and signaling the selected receiver configuration to UE1 and UE2, or some companion thereof.

The network node 200 determines the at least 2 signal strength thresholds (e.g., G1 and G2) for at least two UEs 100 based on a relation or mapping between receiver configurations and signal strength thresholds as previously described. The examples of relation or mapping shown in Tables 1-4 are also applicable for determining signal strength thresholds for two or more UEs 100. For example, if UE1 and UE2 are configured or expected to be with a first receiver configuration and a second receiver configuration respectively, UE1 and UE2 can be configured by the network node with G1 and G2 respectively as shown in Table 3. In another example, if UE1 and UE2 are configured or expected to be with second receiver configuration and first receiver configuration respectively, UE1 and UE2 can be configured with G2 and G1 respectively.

According to a third aspect of the disclosure, a UE 100 is configured to obtain and use a RSRP threshold based on the receiver configuration in the UE 100. The UE 100 determines a receiver type (Rx) configured or expected to be configured in the UE 100 for performing a signal strength measurement, obtains a signal strength threshold (G) associated with the determined receiver configuration, and uses the obtained signal strength threshold for performing one or more radio operations. The parameter G may be pre-defined or configured by the network node 200. Examples of radio procedures are selection of RS for random access transmission, selection between 2-step RA and 4-step RA, CG resource selection for SDT etc. In summary in the third embodiment the UE 100 is configured with at least one signal strength threshold for a radio procedure at a time. The threshold is adaptive and depends on the UE 100 receiver type configured or expected to be configured in the UE. It may be assumed that the UE 100 supports or is capable of at least 2 receiver types. The UE 100 may be using one type of receiver at a time for a certain operation (e.g., signal strength measurement).

In this embodiment, a UE 100 served by a first cell (Cell1) which is managed or served by a first network node 200 (NN1). The UE 100 is capable of or supports at least two receiver configurations (e.g., 1 Rx and 2 Rx, or 2 Rx and 4 Rx or 1 Rx and 4 Rx etc). The UE 100 may be configured to operate using any one of a plurality of supported receiver configurations at a time in Cell1. The receiver configuration may change dynamically or semi-statically e.g., after 1 or multiple time resources. The configured receiver configuration is used by the UE 100 for receiving one or more signals (e.g., RS such as SSB, CSI-RS) and/or channels (e.g., PBCH, PDCCH, PDSCH etc.)

The receiver configuration used by the UE 100 to perform a radio procedure can be determined by the UE 100 autonomously based on one or more pre-defined rules or by based on a message received from the network node (e.g., the network node configuring the UE 100 with certain receiver configuration). Examples of the pre-defined rules to determine the receiver configuration are the same as described in the first embodiment. For example, when the UE 100 is configured to operate on a frequency F1 of a first frequency band B1, the UE 100 may be configured with Rx1. If the UE 100 is configured to operate on a frequency F2 of a second frequency band B2, the UE 100 may be configured with Rx2. In one specific example, B1 is a band below or equal to 2 GHz; while B2 is a band above 2 GHz. In this case in one example, Rx1 and Rx2 corresponds to 1 Rx and 2 Rx respectively. In other embodiments, the UE 100 can be configured by NN1 to use a specific receiver configuration.

According to a method implemented in a UE 100, the UE 100 obtains at least one signal strength threshold (G) which is associated with or related to the receiver configuration configured or expected to be configured in the UE 100, and uses the obtained value of G to perform one or more radio procedures. The value of G may be obtained by the UE 100 based on a predefined mapping or by receiving a message from the network node via DCI, MAC-CE or RRC signaling, in a broadcast message, or in a UE-specific (e.g., dedicated) message. The obtained value of G may selected or determined from a range of values Gr={g1, g2, g3, . . . , gk}. Gr may be predefined or configured by the network node 200. The value of G may further depend on one or more of cell size, type of radio procedures for which the UE 100 uses G, UE 100 physical or geographical location in Cell1, etc. The UE 100 uses G for performing one or more radio procedures e.g., for determining or selecting RS for random access transmission, etc.

In cases where the UE 100 obtains the signal strength threshold based on a relation or mapping between receiver configurations and signal strength thresholds, examples of relation or mapping described in Tables 1-4 are also applicable for determining the signal strength thresholds in the UE 100. For example, if the UE 100 is configured or expected to be configured with a first receiver configuration (e.g., when using a band in GOB1), the UE 100 is configured autonomously or by the network node with G1. In another example, if the UE 100 is configured or expected to be with a second receiver configuration, the UE 100 is configured with G2 (e.g., when using a band in GOB2).

Non-limited examples of radio procedures for which the UE 100 uses the obtained signal strength threshold (e.g., RSRP, path loss etc) include selection of a reference signal for 4-step and 2-step random access, selection between normal uplink (UL) carrier (NUL) and supplementary UL carrier (SUL), selection between 4-step and 2-step RA, signal selection between small data transmission (SDT) and legacy (Non-SDT) transmissions, and selection of resources for SDT.

In one example, the UE 100 is configured with a first receiver configuration (e.g., 1 Rx). Based on its receiver configuration, the UE 100 obtains G1 as the signal strength threshold. The UE 100 is configured with at least two RS configurations (e.g., SSBs such as SSB1 and SSB2). The UE 100 may choose the RS (e.g., one of the SSB1 and SSB2) based on G1 and further uses the selected or determined RS for further determining a random access (RA) transmission resource associated with the selected or determined RS. The UE 100 may further transmit the RA preamble in the determined RA transmission resource. For example, the UE 100 may select or determine the RS whose signal strength (e.g., RSRP) measured by the UE 100 is above G1.

In another example, the UE 100 obtains G2 as the signal strength threshold. The UE 100 is configured with 2-step RA and 4-step RA for RA transmission. The UE 100 may choose between 2-step RA and 4-step RA for RA transmission based on G2 and further transmit the RA preamble using the determined RA type. For example, the may UE 100 choose 2-step RA for RA transmission if the signal strength (e.g., RSRP) measured by the UE 100 is above G2, otherwise the UE 100 chooses 4-step RA for RA transmission.

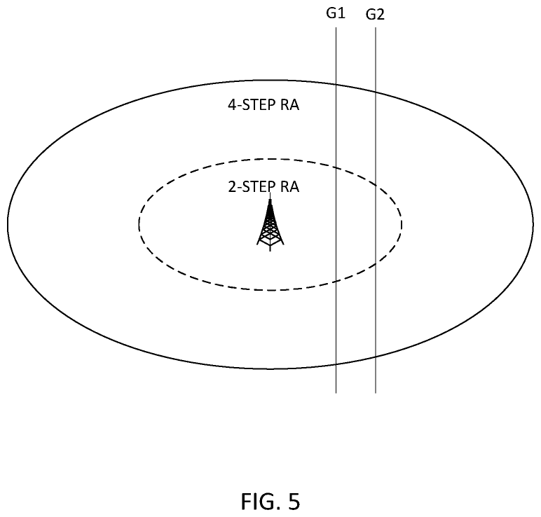

In another example, the cell supports both 2-step RA and 4-step RA and there are UEs 100 with two different receiver configurations (1 Rx and 2 Rx). In this scenario, the network node 200 may need to transmit or the UE 100 may have to determine and use two thresholds, G1 and G2, corresponding to a first receiver configuration and a second receiver configuration respectively in order to select between 2-step RA and 4-step RA as shown in FIG. 5. 2-step RA is applied when the UE 100 is in good coverage conditions because of the differences in measurement accuracy performance. In this example, G1>G2 since the measurements associated with G1 are less accurate (or more dispersed) than G2. If a single threshold is used in this case, the UE 100 may incorrectly select 4-step RA instead of 2-step RA and this may affect the performance.

To support UEs with a 1 RX configuration, the RACH-ConfigCommonTwoStepRA-r16 message can be modified to include new RSRP thresholds for the 1 RX configuration as shown below (additions in bold).

```
RACH-ConfigCommon TwoStepRA-r16 ::= SEQUENCE {
  rach-ConfigGeneric TwoStepRA-r16 RACH-ConfigGenericTwoStepRA-r16,
  msgA-Total NumberOfRA-Preambles-r16 INTEGER (1..63) OPTIONAL, -- Need S
  msgA-SSB-PerRACH-OccasionAndCB-PreamblesPerSSB-r16 CHOICE {
    oneEighth ENUMERATED {n4,n8,n12,n16,n20,n24,n28,n32,n36,n40,n44,n48,n52,n56,n60,n64},
    oneFourth ENUMERATED {n4,n8,n12,n16,n20,n24,n28,n32,n36,n40,n44,n48,n52,n56,n60,n64},
    oneHalf ENUMERATED {n4,n8,n12,n16,n20,n24,n28,n32,n36,n40,n44,n48,n52,n56,n60,n64},
    one ENUMERATED {n4,n8,n12,n16,n20,n24,n28,n32,n36,n40,n44,n48,n52,n56,n60,n64},
    two ENUMERATED {n4,n8,n12,n16,n20,n24,n28,n32},
    four INTEGER (1..16),
    eight INTEGER (1..8),
    sixteen INTEGER (1..4)
  } OPTIONAL, -- Cond 2StepOnly
  msgA-CB-PreamblesPerSSB-PerSharedRO-r16 INTEGER (1..60) OPTIONAL, -- Cond
SharedRO
  msgA-SSB-SharedRO-MaskIndex-r16 INTEGER (1..15) OPTIONAL, -- Need S
  groupB-ConfiguredTwoStepRA-r16 GroupB-ConfiguredTwoStepRA-r16 OPTIONAL, -- Need S
  msgA-PRACH-RootSequenceIndex-r16 CHOICE {
    I839 INTEGER (0..837),
    I139 INTEGER (0..137),
    I571 INTEGER (0..569),
    I1151 INTEGER (0..1149)
  } OPTIONAL, -- Cond 2StepOnly
  msgA-Trans Max-r16 ENUMERATED {n1, n2, n4, n6, n8, n10, n20, n50, n100, n200}  OPTIONAL, -- Need R
  msgA-RSRP-Threshold-r16 RSRP-Range OPTIONAL, -- Cond 2Step4Step
  msgA-RSRP-ThresholdSSB-r16 RSRP-Range OPTIONAL, -- Need R
  msgA-SubcarrierSpacing-r16 SubcarrierSpacing OPTIONAL, -- Cond 2StepOnlyL139
  msgA-RestrictedSetConfig-r16 ENUMERATED {unrestrictedSet, restrictedSetTypeA,
                                    restrictedSetTypeB} OPTIONAL, -- Cond 2StepOnly
  ra-PrioritizationForAccessIdentityTwoStep-r16 SEQUENCE {
    ra-Prioritization-r16 RA-Prioritization,
    ra-PrioritizationForAl-r16 BIT STRING (SIZE (2)
  } OPTIONAL, -- Cond InitialBWP-Only
  ra-ContentionResolution Timer-r16 ENUMERATED {sf8, sf16, sf24, sf32, sf40, sf48, sf56, sf64} OPTIONAL, -- Cond
2StepOnly
  ...,
  [[
  msgA-RSRP-Threshold-1Rx-r17 RSRP-Range OPTIONAL, -- Cond 2Step4Step
  msgA-RSRP-ThresholdSSB-1Rx-r17 RSRP-Range OPTIONAL, -- Need R
  ]]
}
```

In implementations of the network node 200 and UE, the signal strength thresholds (e.g., RSRP threshold) may be an absolute threshold or relative threshold or a combination thereof. An absolute threshold is an absolute value that is used by the UE 100 for comparison to the actual signal strength measurements. A relative threshold is defined in relation to another threshold. For example, a relative threshold may be a factor denoted Δg that is added to or subtracted from another threshold. For example, given a first threshold G1, a second threshold can be given as an amount Δg that is added to or subtracted from G1 to determine G2 (e.g., G2=G1+Δg or G2=G1−Δg). The relation between G1 and G2 can be defined by any determinant function.

In some implementations, only one signal strength threshold (G) is signaled to UEs 100, corresponding to a reference receiver configuration via common RRC signaling in system information. The signaling thresholds for other receiver types will be relative thresholds derived from G based on a model of the measurement error difference compared to the reference receiver type (e.g., based on the RAN4 requirements for the receiver configurations). These offsets, or error models, could be hard-coded in the specification. For example, the signal strength threshold (G2) for UE 100 receiver type with 2 Rx branch is broadcast in system information. UEs with receiver type with 1 Rx branch, would then derive their corresponding signal strength threshold (G1) from G2. Since, assuming the same measurement samples, 1 Rx are subject to more bias (e.g., ±6.5 dB error) compared to measurements done using 2 Rx (e.g., ±4.5 dB error), the offset to be applied could e.g., be hardcoded to be 2 dB in this case. Therefore, the following derivation would be used, G1=G2+2 dB. In this way, UEs with 1 Rx branch will effectively see a higher RSRP-threshold, which is the result of 2 dB penalty due to their worse measurement accuracy. If this is not applied, the measurement error may cause 1 Rx UEs to camp on a cell when they really can or should not.

In embodiments of the present disclosure, the UE 100 performs signal strength measurements and compares the signal strength measurements to the configured signal strength threshold to determine an action to take. The signal strength measurements may be performed on reference signals transmitted by a cell, such as the SSB, CSI-RS, PRS, etc. The signal strength threshold may be used, for example, to select a reference signal for 4-step and 2-step random access, to choose between normal uplink (UL) carrier (NUL) and supplementary UL carrier (SUL), to choose 4-step and 2-step RA, to choose between small data transmission (SDT) and legacy (Non-SDT) transmissions, and to select resources for SDT. Examples of signal strength measurements include path loss, RSRP etc. Examples of RSRP are SS-RSRP, CSI-RSRP, SSB based L1-RSRP, CSI-RS based L1-RSRP, PRS-RSRP etc.

The principle of adaptive RSRP thresholds as herein described can be applied to other radio procedure parameters. That is, any parameter controlling the radio procedure can potentially be adapted based on the number of Rx branches.

According to a fourth aspect of the disclosure, methods are provided configuring a UE 100 with timer and counter values based on the receiver configuration in the UE. In these embodiments, the network node 200 determines a receiver configuration and/or number of receivers supported in a UE 100 to configure the UE, or alternatively, provides the UE 100 with multiple values in broadcast or dedicated signaling to configure a timer(s) and/or counter(s) for a particular procedure(s) based on the receiver type and/or number of receivers in the UE. One example of such timer and counter is T310 and N310 used in the radio link failure and RRC connection reestablishment procedures. Other counters and timers associated with measurements, e.g., to confirm whether the UE 100 is out-of-sync, similar to N310 and T310 can also be considered. The counter N310 and timer T310 are configured with different values based on the receiver configuration (e.g., number of receive branches that the UE 100 uses). This configuration can be provided by the network based on the UE 100 capabilities determined or by the UE 100 once network provides multiple options that should be applied with respect to the receiver configuration and/or number of receivers that the UE 100 uses.

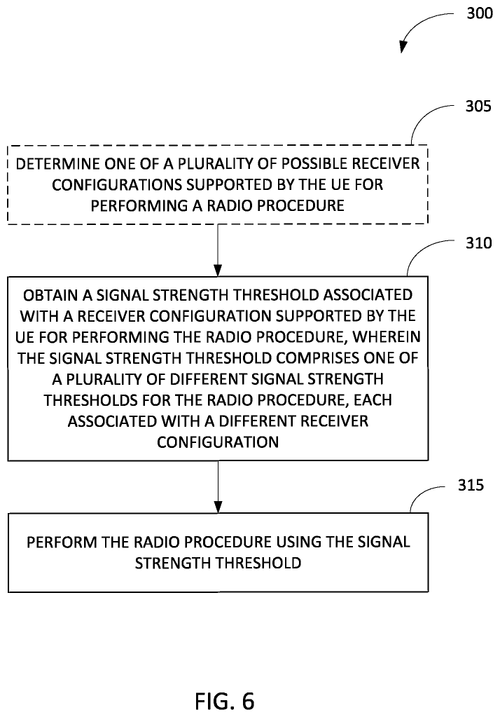

FIG. 6 illustrates a method 300 implemented by a user equipment (UE) in a wireless communication network. In some embodiments, the UE 100 optionally determines one of a plurality of possible receiver configurations supported by the UE 100 for a radio procedure (block 305). The method 300 comprises obtaining a signal strength threshold associated with a receiver configuration supported by the UE 100 for performing a radio procedure (block 310). The signal strength threshold comprises one of a plurality of different signal strength thresholds for the radio procedure, each associated with a different receiver configuration. The method further comprises performing the radio procedure using the signal strength threshold (block 315).

In some embodiments of the method 300, obtaining the signal strength threshold comprises receiving the signal threshold from a network node 200.

In some embodiments of the method 300, receiving the signal strength threshold from the network node 200 comprises receiving the signal strength threshold in a broadcast message over a broadcast channel.

In some embodiments of the method 300, the signal strength threshold is received in a system information message.

In some embodiments of the method 300, the system information message comprises the plurality of different signal strength thresholds for the radio procedure.

In some embodiments of the method 300, obtaining the signal strength threshold further comprises selecting, from the plurality of different signal strength thresholds, the signal strength threshold associated with the receiver configuration supported by the UE.

In some embodiments of the method 300, the signal strength threshold comprises receiving the signal threshold from the network node 200 in a dedicated signaling message.

In some embodiments of the method 300, obtaining a signal strength threshold associated with a receiver configuration supported by the UE 100 comprises determining one of a plurality of different receiver configurations supported by the UE 100 for performing the radio procedure, and obtaining a signal strength threshold associated with the determined receiver configuration.

In some embodiments of the method 300, determining one of a plurality of different receiver configurations supported by the UE 100 for performing the radio procedure comprises determining a number of receivers to use for performing the radio procedure.

In some embodiments of the method 300, determining a receiver configuration supported by the UE for performing the radio procedure comprises determining whether the receiver can mitigate interference when performing the radio procedure.

In some embodiments of the method 300, determining one of a plurality of different receiver configurations supported by the UE 100 for performing the radio procedure further comprises determining the receiver configuration based on one or more of a frequency band used by the UE 100 to perform the radio procedure, the radio conditions experienced by the UE, the battery status of the UE, a Quality of Service (QOS) requirement, a target data rate, a default receiver configuration.

Some embodiments of the method 300 further comprise sending, to the network node 200, an indication of the receiver configuration to be used for the radio procedure.

In some embodiments of the method 300, determining one of a plurality of different receiver configurations supported by the UE 100 for performing the radio procedure further comprises receiving the receiver configuration for the radio procedure from a network node 200.

In some embodiments of the method 300, the signal strength threshold is based on a mapping between a plurality of receiver configurations and the plurality of signal strength thresholds. The mapping may be predefined or configured by the network node 200.

In some embodiments of the method 300, receiving the signal strength threshold for the radio procedure comprises receiving, from the network node 200, a reference to an entry in a mapping table, wherein the mapping table comprises a plurality of entries corresponding to the mapping between receiver configurations and signal strength thresholds.

Some embodiments of the method 300 further comprise receiving a mapping table from the network node 200, wherein the mapping table comprises a plurality of entries corresponding to the mapping between receiver configurations and signal strength thresholds.

In some embodiments of the method 300, obtaining the signal strength threshold comprises obtaining an absolute threshold.

In some embodiments of the method 300, obtaining the signal strength threshold comprises obtaining a relative threshold.

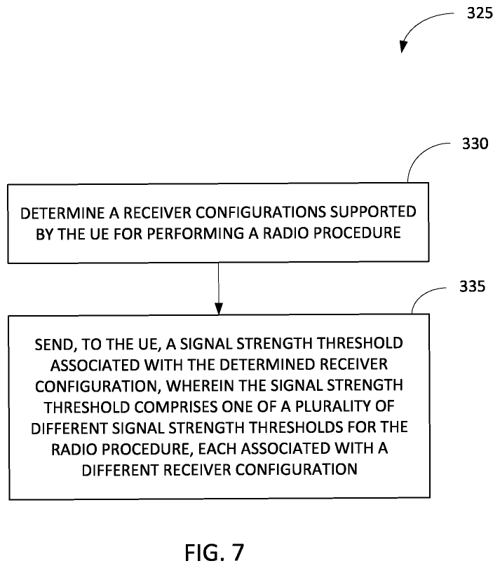

FIG. 7 illustrates another method 325 implemented by a network node 200 in a wireless communication network, the method 325 comprises determining a receiver configuration supported by a first UE 100 for performing a radio procedure (block 330). The method further comprises sending, to the first UE, a signal strength threshold associated with the determined receiver configuration (block 335). The signal strength threshold comprises one of a plurality of different signal strength thresholds for the radio procedure, each associated with a different receiver configuration.

In some embodiments of the method 325, determining a receiver configuration supported by the UE 100 for performing the radio procedure comprises determining a number of receivers used by the UE 100 to perform the radio procedure.

In some embodiments of the method 325, determining a receiver configuration supported by the UE 100 for performing the radio procedure comprises determining whether the receiver can mitigate interference when performing the radio procedure.

In some embodiments of the method 325, determining one of a plurality of different receiver configurations supported by the UE 100 for performing the radio procedure further comprises determining the receiver configuration based on one or more of a frequency band used by the UE 100 to perform the radio procedure, the radio conditions experienced by the UE 100, the battery status of the UE, a Quality of Service (QOS) requirement, a target data rate, a default receiver configuration.

In some embodiments of the method 325, determining a receiver configuration supported by a first UE for performing a radio procedure comprises receiving an indication of the receiver configuration from the UE.

Some embodiments of the method 325 further comprise sending, to the UE 100, an indication of the receiver configuration to be used for the radio procedure.

In some embodiments of the method 325, sending a signal strength threshold to the UE 100 comprises broadcasting the signal strength threshold in a broadcast message over a broadcast channel. In one example, the signal strength threshold is transmitted in a system information message.

In some embodiments of the method 325, a signal strength threshold to the UE 100 comprises sending the signal strength threshold to the UE 100 in a dedicated message.

In some embodiments of the method 325, the signal strength threshold is based on a mapping between a plurality of allowable receiver configurations and the plurality of signal strength thresholds. The mapping can be predefined by an applicable standard or configured by the network node 200.

In some embodiments of the method 325, sending the signal strength threshold to the UE 100 for the radio procedure comprises sending, to the UE, a reference to an entry in a mapping table, wherein the mapping table comprises a plurality of entries corresponding to the mapping between receiver configurations and signal strength thresholds.

Some embodiments of the method 325 further comprise sending, to the UE 100, a mapping table representing the mapping between receiver configurations and signal strength thresholds.

In some embodiments of the method 325, the signal strength threshold comprises an absolute threshold, i.e., an absolute value. In other embodiments, the signal strength threshold comprises a relative threshold, i.e., defined by reference to another threshold.

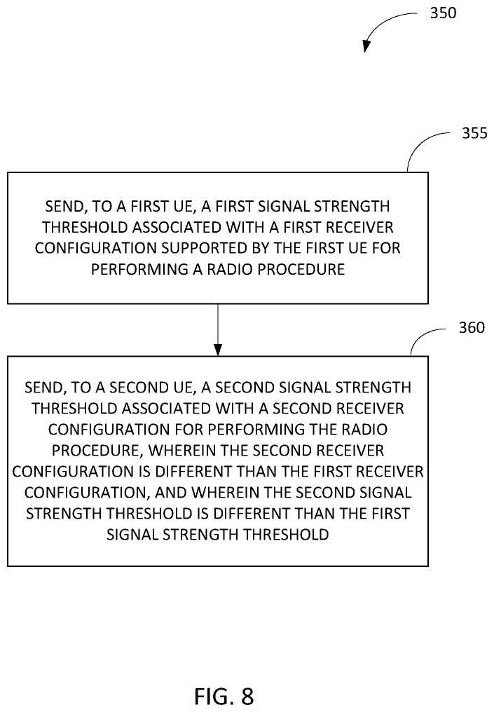

FIG. 8 illustrates a method 350 implemented by a network node 200 in a wireless communication network. The method comprises sending, to a first UE 100, a first signal strength threshold associated with a first receiver configuration supported by the first UE 100 for performing a radio procedure (block 355). The method further comprises sending, to a second UE 100, a second signal strength threshold associated with a second receiver configuration for performing the radio procedure, wherein the second receiver configuration is different than the first receiver configuration, and wherein the second signal strength threshold is different than the first signal strength threshold (block 360).

In some embodiments of the method 350, sending the first and second receiver configurations comprises determining the first receiver configuration, sending the signal strength threshold associated with the first receiver configuration to the first UE 100, determining the second receiver configuration, and sending the signal strength threshold associated with the second receiver configuration to the second UE 100.

In some embodiments of the method 350, determining the first and second receiver configurations comprises determining a number of receivers used by the first and second UEs 100 respectively to perform the radio procedure.

In some embodiments of the method 350, determining a receiver configuration supported by the UE 100 for performing the radio procedure comprises determining whether the receiver can mitigate interference when performing the radio procedure.

In some embodiments of the method 350, determining the first and second receiver configurations comprises determining the first and second receiver configurations based on one or more of a frequency bands used by the first and second UEs 100 respectively to perform the radio procedure, the radio conditions experienced by the first and second UEs, 100 the battery statuses of the first and second UEs 100, a Quality of Service (QOS) requirements for the first and second UEs, a target data rates for the first and second UEs, or a default receiver configuration.

In some embodiments of the method 350, determining a receiver configuration supported by a first UE 100 for performing a radio procedure comprises receiving an indication of the receiver configuration from the UE 100.

Some embodiments of the method 350 further comprise sending, to each the first and second UEs 100, an indication of the receiver configuration to be used for the radio procedure.

In some embodiments of the method 350, sending the first and second signal strength thresholds comprises broadcasting the first and second signal strength thresholds in a broadcast message over a broadcast channel.

In some embodiments of the method 350, the first and second signal strength thresholds are broadcast in system information over the broadcast channel.

In some embodiments of the method 350, sending the first and second signal strength thresholds comprises sending the first and second signal strength thresholds in dedicated messages.

In some embodiments of the method 350, the first and second signal strength thresholds are based on a mapping between allowable receiver configurations and the plurality of signal strength thresholds. The mapping may be predefined by an applicable standard or configured by the network node 200.

In some embodiments of the method 350, sending the first and second signal strength thresholds for the radio procedure comprises sending, to the UE 100, a reference to an entry in a mapping table, wherein the mapping table comprises a plurality of entries corresponding to the mapping between receiver configurations and signal strength thresholds.

In some embodiments of the method 350, sending, to the first and second UEs 100, a mapping table representing the mapping between receiver configurations and signal strength thresholds.

In some embodiments of the method 350, at least one of the first and second signal strength thresholds comprises an absolute threshold. In other embodiments, at least one of the first and second signal strength thresholds comprises a relative threshold.

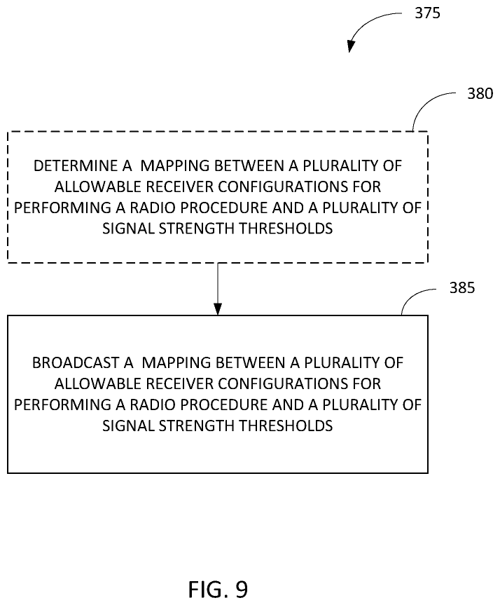

FIG. 9 illustrates another method 375 implemented by a network node 200. In some embodiments, the network node 200 optionally determines the mapping between the plurality of allowable receiver configurations for performing a radio procedure and a plurality of signal strength thresholds (block 380). The network node 200 broadcasts the mapping between a plurality of allowable receiver configurations for performing a radio procedure and a plurality of signal strength thresholds (block 385).

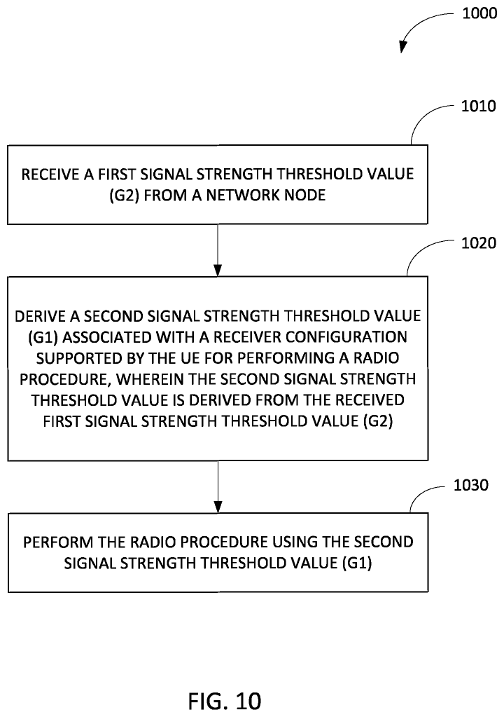

FIG. 10 illustrates another method 1000 implemented by a user equipment (UE) 100 in a wireless communication network. The method 1000 comprises receiving a first signal strength threshold value (G2) from a network node (block 1010). The method further comprises deriving a second signal strength threshold value (G1) associated with a receiver configuration supported by the UE 100 for performing a radio procedure (block 1020). The second signal strength threshold value (G1) is derived from the received first signal strength threshold value (G2). The method 1000 further comprises performing the radio procedure using the second signal strength threshold value (G1) (block 1030).

In some embodiments of the method 1000, the first signal strength threshold value (G2) is for a receiver configuration with two receive branches.

In some embodiments of the method 1000, the receiver configuration supported by the UE 100 is a receiver configuration with one receive branch, and the second signal strength threshold value (G1) is for a receiver configuration with one receive branch. In some embodiments of the method 1000, the UE 100 further supports a receiver configuration with two receive branches.

In some embodiments of the method 1000, the second signal strength threshold value (G1) is derived from the received first signal strength threshold value (G2) and an offset (Δg).

In some embodiments of the method 1000, the second signal strength threshold value (G1) is the sum of the received first signal strength threshold value (G2) and the offset (Δg).

In some embodiments of the method 1000, the radio procedure comprises selection of reference signal for random access transmission, selection between normal uplink carrier and supplementary uplink carrier, selection between 2-step random access and 4-step random access, selection between small data transmission and legacy transmission, and/or selection of resources for small data transmission.

In some embodiments of the method 1000, deriving a second signal strength threshold value (G1) associated with a receiver configuration supported by the UE 100 comprises determining one of a plurality of different receiver configurations supported by the UE 100 for performing the radio procedure; and deriving a signal strength threshold value associated with the determined receiver configuration.

Some embodiments of the method 1000 further comprise sending, to the network node 200, an indication of the receiver configuration to be used for the radio procedure. In some embodiments of the method 1000, the first signal strength threshold value (G2) is an absolute threshold value.

In some embodiments of the method 1000, the second signal strength threshold value (G1) is a relative threshold value.

In some embodiments of the method 1000, the first signal strength threshold value (G2) is received from the network node 200 in a broadcast message and/or a system information message.

A user equipment (UE) 100 in a wireless communication network may be configured to perform any embodiment of the method 1000. A user equipment (UE) 400, in a wireless communication network, may comprise communication circuitry configured to communicate with a network node 500 in the wireless communication network. The UE 400 may further comprise processing circuitry, wherein the processing circuitry may be configured to perform any embodiment of the method 1000.

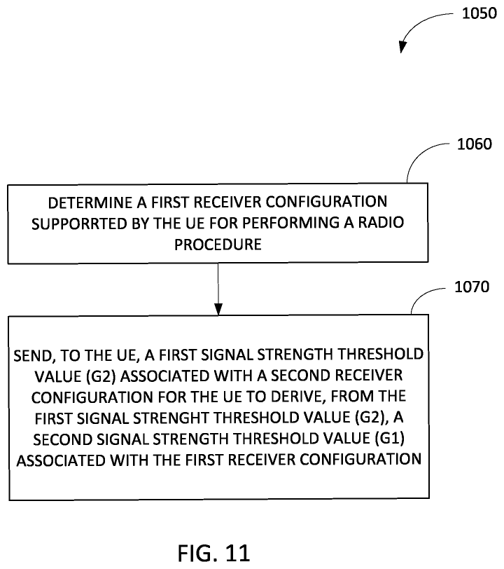

FIG. 11 illustrates another method 1050 implemented by a network node 200. The method 1050 comprises determining a first receiver configuration supported by a UE 100 for performing a radio procedure (block 1060). The method further comprises sending, to the UE 100, a first signal strength threshold value (G2) associated with a second receiver configuration (block 1070) for the UE 100 to derive, from the first signal strength threshold value (G2), a second signal strength threshold value (G1) associated with the first receiver configuration.

Some embodiments of the method 1050 further comprise communicating with the UE 100 based on the derived second signal strength threshold value (G1).

In some embodiments of the method 1050, the second receiver configuration is a receiver configuration with two receive branches, and the first signal strength threshold value (G2) is for a receiver configuration with two receive branches.

In some embodiments of the method 1050, the first receiver configuration supported by the UE 100 is a receiver configuration with one receive branch, and the second signal strength threshold value (G1) is for a receiver configuration with one receive branch.

In some embodiments of the method 1050, the UE 100 further supports a receiver configuration with two receive branches.

In some embodiments of the method 1050, the second signal strength threshold value (G1) is derived from the first signal strength threshold value (G2) and an offset (Δg). In some embodiments of the method 1050, the second signal strength threshold value (G1) is the sum of the first signal strength threshold value (G2) and the offset (Δg).

In some embodiments of the method 1050, the radio procedure comprises selection of reference signal for random access transmission, selection between normal uplink carrier and supplementary uplink carrier, selection between 2-step random access and 4-step random access, selection between small data transmission and legacy transmission, and/or selection of resources for small data transmission.

In some embodiments of the method 1050, determining a first receiver configuration supported by a UE 100 for performing a radio procedure comprises receiving an indication of the receiver configuration from the UE 100.

In some embodiments of the method 1050, the first signal strength threshold value (G2) comprises an absolute threshold value.

In some embodiments of the method 1050, the second signal strength threshold value (G1) comprises a relative threshold value.

In some embodiments of the method 1050, sending a first signal strength threshold value (G2) to the UE 100 comprises sending the first signal strength threshold value (G2) in a broadcast message and/or a system information message.

A network node 200 in a wireless communication network may be configured to perform any embodiment of the method 1050. A network node 500, in a wireless communication network, may comprise communication circuitry configured to communicate with a user equipment 400 in the wireless communication network. The network node may further comprise processing circuitry, wherein the processing circuitry may be configured to perform any embodiment of the method 1050.

An apparatus can perform the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

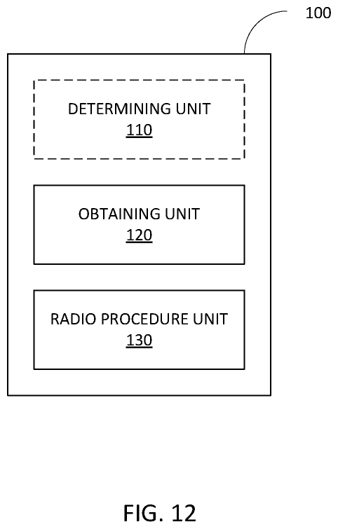

FIG. 12 illustrates an exemplary UE 100 according to one embodiment. The UE 100 comprises an optional determining unit 110, an obtaining unit 120, and a radio procedure unit 130. The various units 110-130 can be implemented by hardware and/or by software code that is executed by one or more processors or processing circuits. The determining unit 110, when present, is configured to determine one of a plurality of different receiver configurations supported by the UE100 for performing the radio procedure. The obtaining unit 120 is configured to obtain a signal strength threshold associated with a receiver configuration supported by the UE 100 for performing a radio procedure. The signal strength threshold comprises one of a plurality of different signal strength thresholds for the radio procedure, each associated with a different receiver configuration. The radio procedure unit 130 is configured to perform the radio procedure using the signal strength threshold.

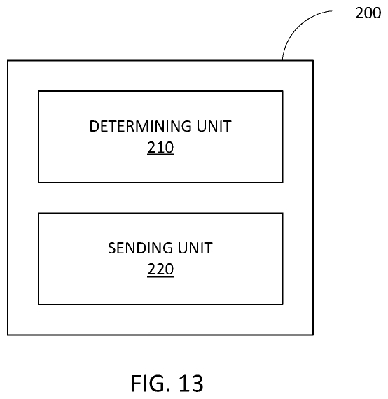

FIG. 13 illustrates an exemplary network node 200 according to one embodiment. The network node 200 comprises a determining unit 210 and a sending unit 220. The various units 210-220 can be implemented by hardware and/or by software code that is executed by one or more processors or processing circuits. The determining unit 210 is configured to determine a receiver configuration supported by a first UE 100 for performing a radio procedure. The sending unit 220 is configured to send, to the first UE 100, a signal strength threshold associated with the determined receiver configuration. The signal strength threshold comprises one of a plurality of different signal strength thresholds for the radio procedure, each associated with a different receiver configuration.

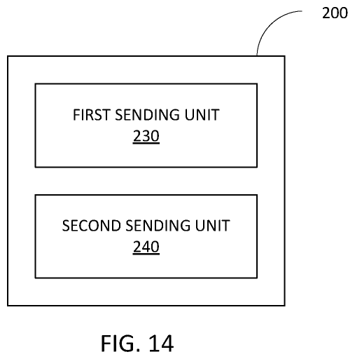

FIG. 14 illustrates another exemplary network node 200 according to one embodiment. The network node 200 comprises a first sending unit 230 and a second sending unit 240. The various units 230-240 can be implemented by hardware and/or by software code that is executed by one or more processors or processing circuits. The first sending unit 230 is configured to send, to a first UE 100, a first signal strength threshold associated with a first receiver configuration supported by the first UE 100 for performing a radio procedure. The second sending unit 240 is configured to send, to a second UE 100, a second signal strength threshold associated with a second receiver configuration for performing the radio procedure. The second receiver configuration is different than the first receiver configuration, and wherein the second signal strength threshold is different than the first signal strength threshold.

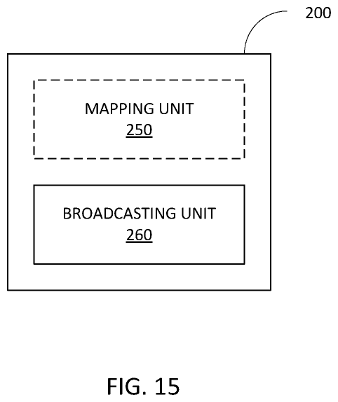

FIG. 15 illustrates another exemplary network node 200 according to one embodiment. The network node 200 comprises an optional mapping unit 250 and a broadcasting unit 260. The various units 250-260 can be implemented by hardware and/or by software code that is executed by one or more processors or processing circuits. The mapping unit 250, when present, is configured to determine the mapping between the plurality of allowable receiver configurations for performing a radio procedure and a plurality of signal strength thresholds. The broadcasting unit 260 is configured to broadcast the mapping between a plurality of allowable receiver configurations for performing a radio procedure and a plurality of signal strength thresholds.

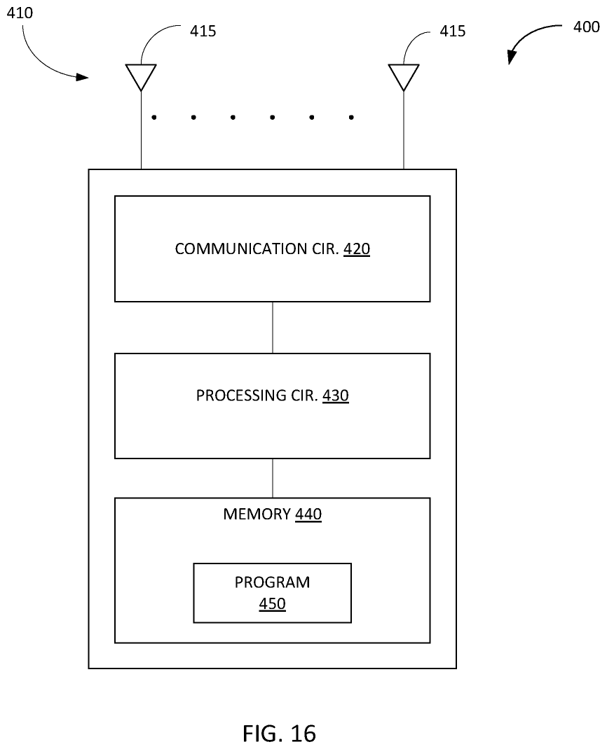

FIG. 16 illustrates a UE 400 according to one embodiment that may be configured to function as a base station 100. The UE 400 comprises an antenna array 410 with multiple antenna elements 415, communication circuitry 420, a processing circuitry 430, and memory 440.

The communication circuitry 420 is coupled to the antennas 415 and comprises the radio frequency (RF) circuitry for transmitting and receiving signals over a wireless communication channel. The communication circuitry 420 may, for example, comprise a transmitter and receiver configured to operate according to the 5G/NR standard modified as describe herein.

The processing circuitry 430 controls the overall operation of the UE 400 and processes the signals transmitted to or received by the UE 400. The processing circuitry 430 is configured to perform the methods and processes as herein described including the method 200 shown in FIG. 6. The processing circuitry 430 may comprise one or more microprocessors, hardware, firmware, or a combination thereof.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores a computer program 450 comprising executable instructions that configure the processing circuitry 430 to implement the methods and processes as herein described including the method 200 shown in FIG. 6. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

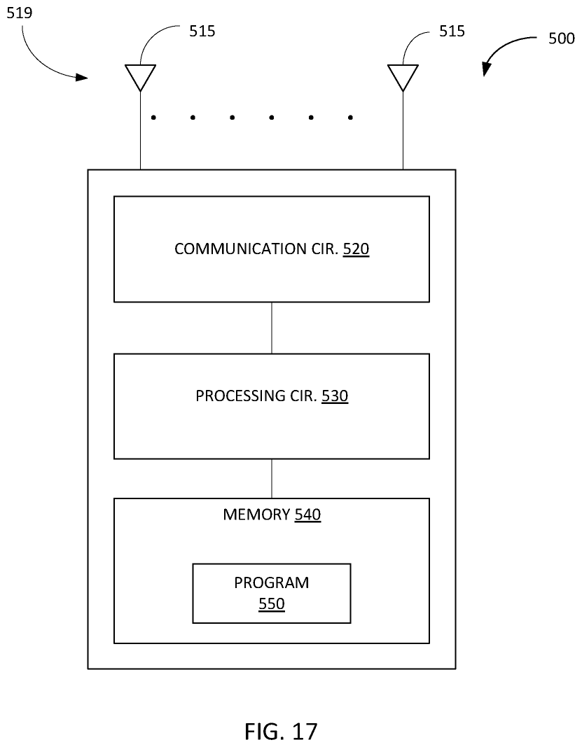

FIG. 17 illustrates a network node 500 according to one embodiment that may be configured to function as a base station 100. The network node 500 comprises an antenna array 510 with multiple antenna elements 515, communication circuitry 520, a processing circuitry 530, and memory 540.

The communication circuitry 520 is coupled to the antennas 515 and comprises the radio frequency (RF) circuitry for transmitting and receiving signals over a wireless communication channel. The communication circuitry 520 may, for example, comprise a transmitter and receiver configured to operate according to the 5G/NR standard modified as describe herein.

The processing circuitry 530 controls the overall operation of the network node 500 and processes the signals transmitted to or received by the network node 500. The processing circuitry 530 is configured to perform the methods and processes as herein described including the methods 300, 325, 350 and 375 shown in FIGS. 7-10. The processing circuitry 530 may comprise one or more microprocessors, hardware, firmware, or a combination thereof.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuitry 530 to implement the methods and processes as herein described including the methods 300, 325, 350 and 375 shown in FIGS. 7-10. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

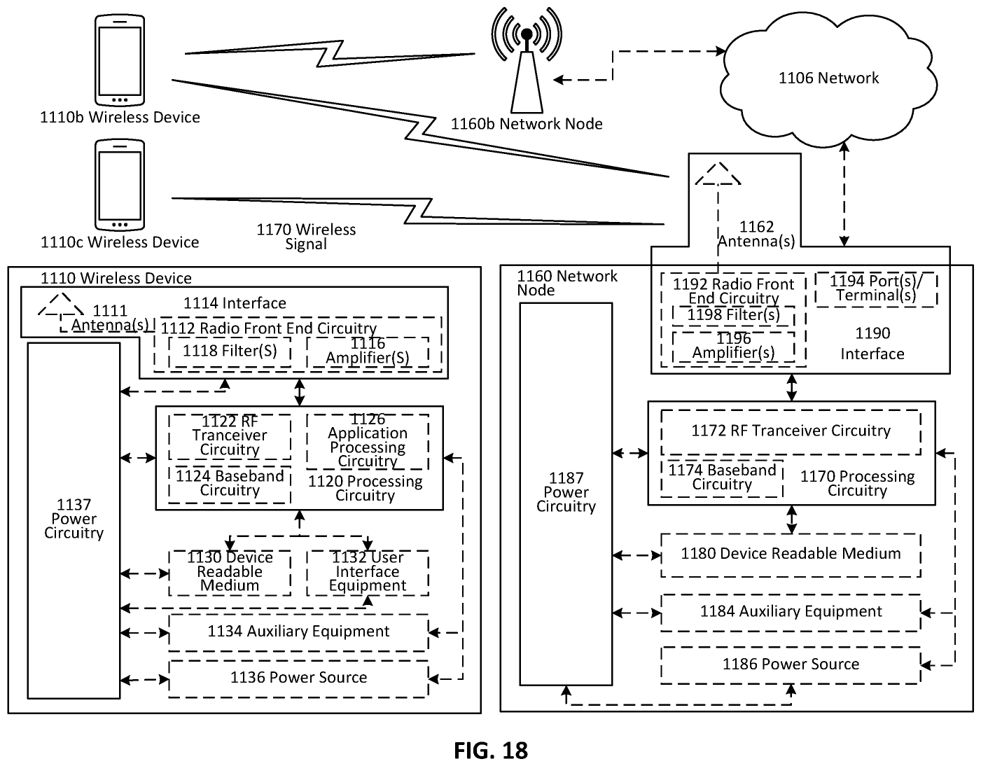

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 18 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc., A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120. In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

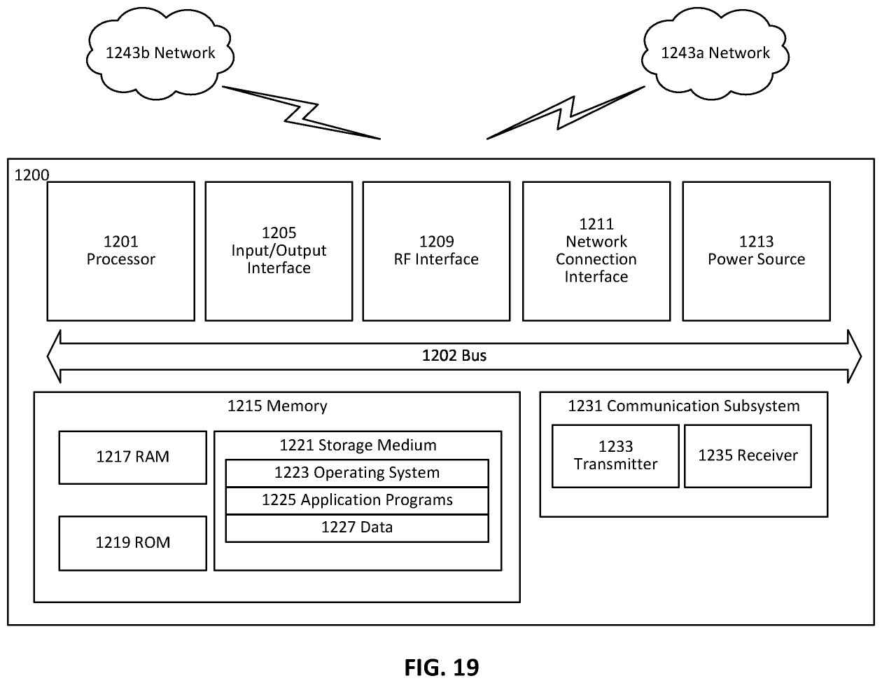

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 19, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 19, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

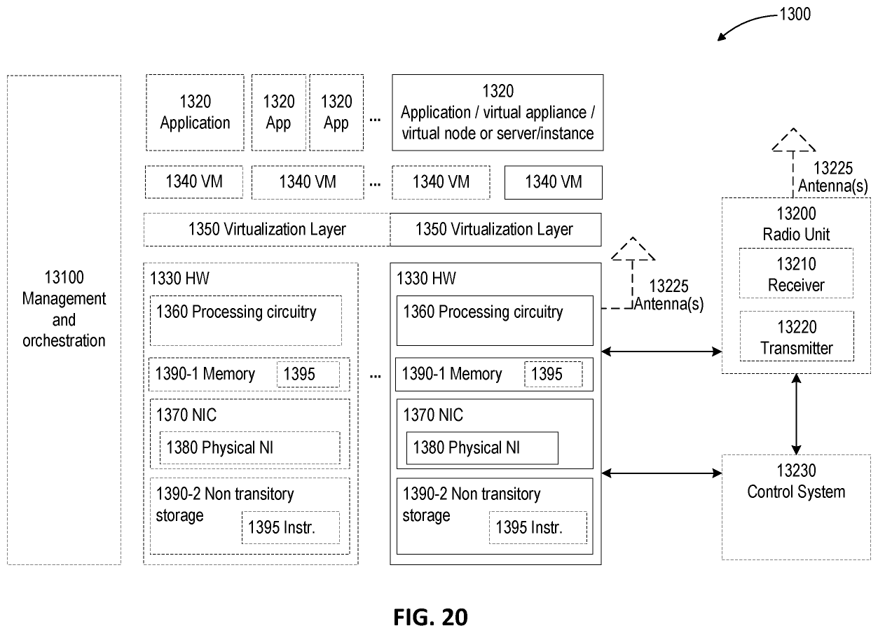

FIG. 20 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 20, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 20.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

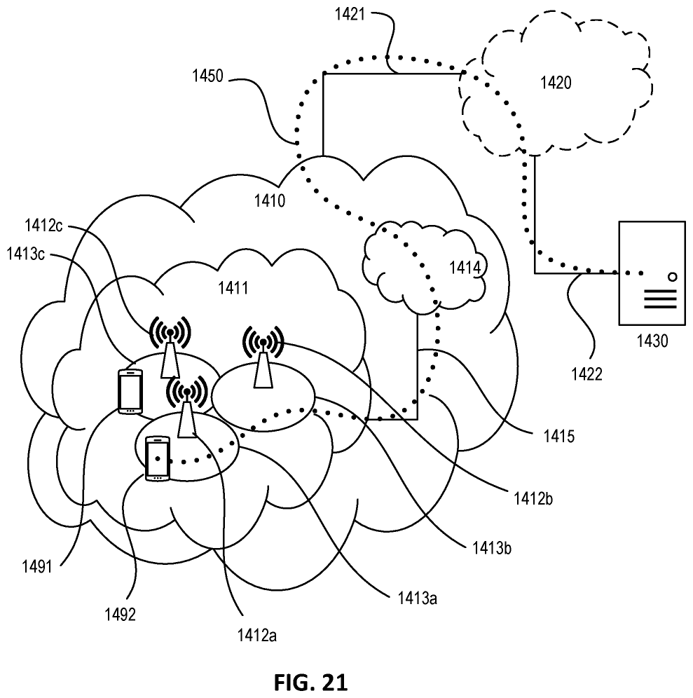

FIG. 21 illustrates a telecommunication network connected via an intermediate network to a host computer in accordance with some embodiments. In particular, with reference to FIG. 21, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 21 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

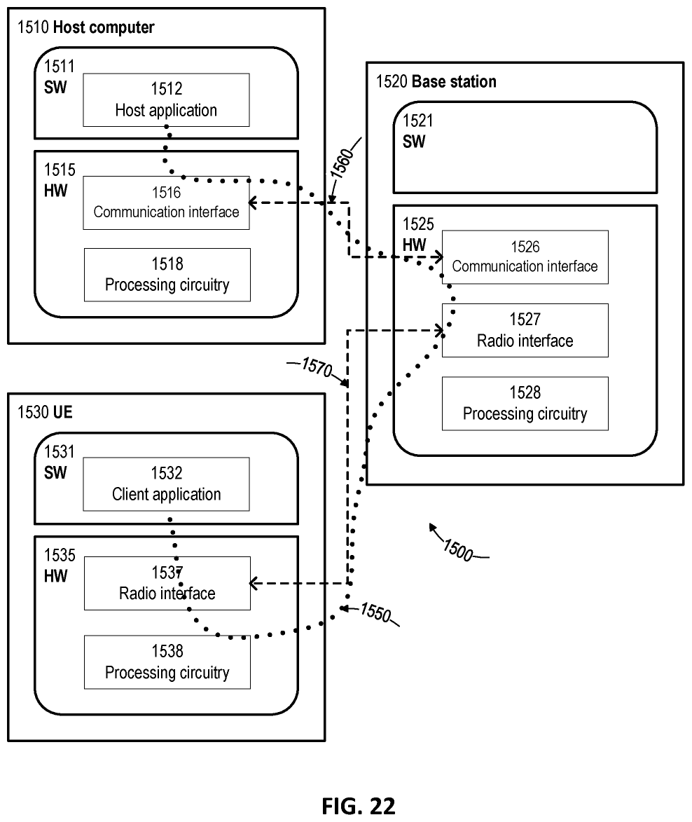

Example implementations, in accordance with an embodiment, of the UE, base station and host computer discussed in the preceding paragraphs will now be described with reference to FIG. 22. FIG. 22 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 22) served by base station 1520. Communication interface 1526 may be configured to facilitate connection 1560 to host computer 1510. Connection 1560 may be direct or it may pass through a core network (not shown in FIG. 22) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 22 may be similar or identical to host computer 1430, one of base stations 1412a, 1412b, 1412c and one of UEs 1491, 1492 of FIG. 21, respectively. This is to say, the inner workings of these entities may be as shown in FIG. 22 and independently, the surrounding network topology may be that of FIG. 21.

In FIG. 22, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the power consumption of the wireless device and thereby provide benefits such as extended battery lifetime.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

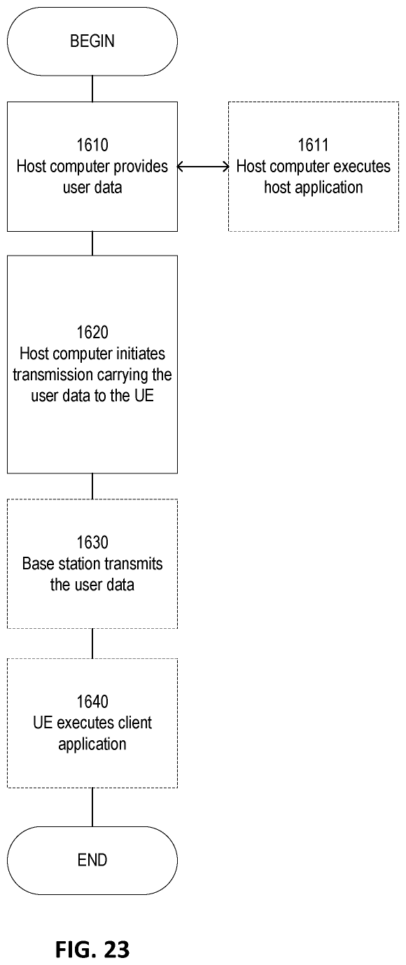

FIG. 23 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 23 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

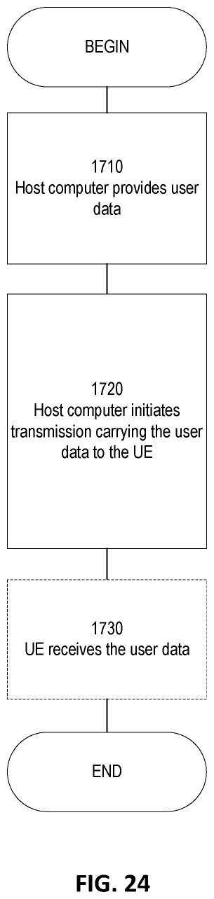

FIG. 24 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 24 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

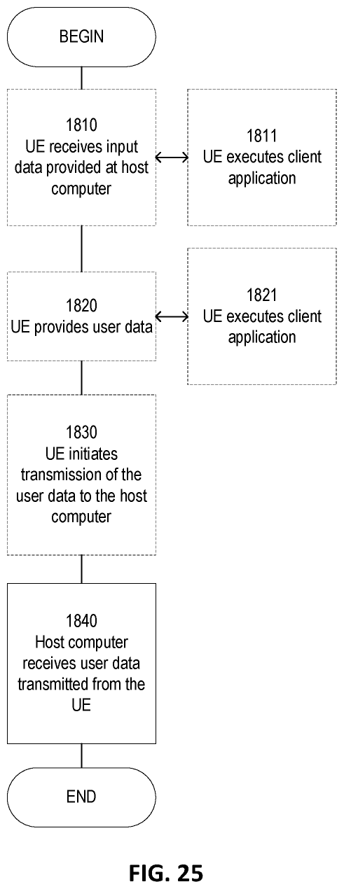

FIG. 25 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 25 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

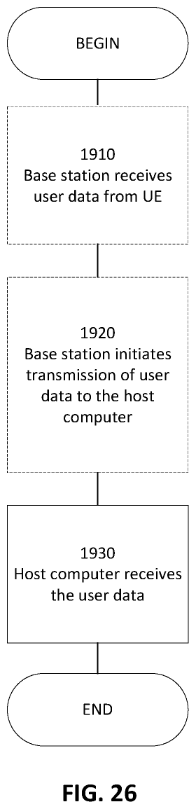

FIG. 26 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 26 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### Impact on Measurement Accuracy on RA

The RedCap UE may support 1 Rx or 2 Rx or different number of Rx depending on the band. The number of UE receivers (1 Rx or 2 Rx) will be Redcap UE capability. For example, one RedCap UE may indicate support for 1 Rx while another RedCap UE may indicate support for 2 Rx even for the same band. Therefore, in the same cell there can be RedCap UEs with some supporting 1 Rx or some supporting 2 Rx. Furthermore, in the same cell there can be redcap UEs supporting 1 Rx as well as normal/legacy NR UEs supporting 2 Rx. Studies has shown that a considerably higher measurement bias is observed with 1 Rx compared to 2 Rx. Thus, RSRP accuracy requirements may be relaxed for 1 Rx UE compared to 2 Rx UE, e.g. relaxation by 1.5 dB-2 dB can be considered.

According to current procedures, RSRP based thresholds are used in various requirements such as RA. For instance, in current RA requirements, when both 4-step RA and 2-step RA are configured then the UE selects 2-step RA if the RSRP of the reference SSB is above RSRP threshold (msgA-RSRP-Threshold). Otherwise, the UE selects 4-step RA. Since all legacy UEs support 2 Rx, the RSRP measurements are performed with 2 Rx, therefore only a single RSRP threshold is used for the RA selection or for any other procedure using RSRP threshold. However, since there will be some UEs operating with both 1 Rx (RedCap UEs) and 2 Rx (e.g. legacy NR UEs) in same cell, two different RSRP thresholds would be needed to avoid network performance degradation, e.g. UEs incorrectly selecting 4-step RA instead 2-step RA and vice versa, avoiding coverage holes etc. For example, in RRC idle/inactive states the gNB may signal two different RSRP thresholds. The RSRP threshold range can be the same for both cases. When comparing to Cat-M or NB-IoT, all those UEs were operating with 1 Rx and thus a single threshold was used which is derived based on the 1 Rx measurement performance. RedCap, on the other hand, may need two different RSRP thresholds that are derived and configured by gNB based on 1 Rx- and 2 Rx measurement accuracy performance.

Following list of RSRP based thresholds are used in legacy NR requirements and need new thresholds based on 1 Rx measurement performance: rsrp-ThresholdSSB, rsrp-ThresholdCSI-RS, msgA-RSRP-ThresholdSSB, rsrp-ThresholdSSB-SUL, msgA-RSRP-Threshold.

Thus, there might be a need to introduce a separate RSRP thresholds for RedCap 1 Rx UE in procedures that depend on RSRP thresholds. RSRP based thresholds assuming 2 Rx UEs are used in various procedures in current specification including: rsrp-ThresholdSSB, rsrp-ThresholdCSI-RS, msgA-RSRP-ThresholdSSB, rsrp-ThresholdSSB-SUL, msgA-RSRP-Threshold. RSRP measurement accuracy is considerably degraded for 1 Rx UE compared to 2 Rx UE for RedCap. For example, separate RSRP thresholds may be introduced for RedCap UE with 1 Rx in procedures that depend on RSRP based thresholds such as RA.

Studies has been performed on RSRP measurement performance for RedCap UE with 1 Rx and has found that the measurement accuracy is degraded by [1.5 dB-2.0 dB] for 1 Rx UE compared to 2 Rx UE. The Redcap UEs supporting 1 Rx may coexist with legacy NR UEs supporting 2 Rx in the same cell. Therefore, there might be a need to introduce separate RSRP based threshold for Redcap UE supporting 1 Rx for a procedure based on comparison of the RSRP with RSRP threshold. The range of the new RSRP threshold for RedCap UE supporting 1 Rx can be the same as used for the existing RSRP threshold for the UEs with 2 Rx UE, e.g., legacy NR UE or RedCap UE supporting 2 Rx.

### NUMBERED EXAMPLES

1. An example method implemented by a user equipment (UE) in a wireless communication network, the method comprising:
obtaining a signal strength threshold associated with a receiver configuration supported by the UE for performing a radio procedure, wherein the signal strength threshold comprises one of a plurality of different signal strength thresholds for the radio procedure, each associated with a different receiver configuration; and
performing the radio procedure using the signal strength threshold.
   2. The method of example 1, wherein obtaining the signal strength threshold comprises receiving the signal threshold from a network node.
   3. The method of example 2, wherein receiving the signal strength threshold from the network node comprises receiving the signal strength threshold in a broadcast message.
   4. The method of any one of examples 2-3, wherein the signal strength threshold is received in a system information message.
   5. The method of example 4, wherein the system information message comprises the plurality of different signal strength thresholds for the radio procedure.
   6. The method of any one of examples 1-5, wherein obtaining the signal strength threshold further comprises selecting, from the plurality of different signal strength thresholds, the signal strength threshold associated with the receiver configuration supported by the UE.
   7. The method of example 2, wherein obtaining the signal strength threshold comprises receiving the signal threshold from the network node in a dedicated signaling message.
   8. The method of any one of examples 1-7, wherein obtaining a signal strength threshold associated with a receiver configuration supported by the UE comprises:
determining one of a plurality of different receiver configurations supported by the UE for performing the radio procedure; and
obtaining a signal strength threshold associated with the determined receiver configuration.
   9. The method of example 8, wherein determining one of a plurality of different receiver configurations supported by the UE for performing the radio procedure comprises determining a number of receivers to use for performing the radio procedure.
   10. The method of example 8, wherein determining one of a plurality of different receiver configurations supported by the UE for performing the radio procedure comprises determining whether the receiver can mitigate interference when performing the radio procedure.
   11. The method of any one of examples 8-10, wherein determining one of a plurality of different receiver configurations supported by the UE for performing the radio procedure further comprises determining the receiver configuration based on one or more of:
a frequency band used by the UE to perform the radio procedure;
the radio conditions experienced by the UE;
the battery status of the UE;
a Quality of Service (QOS) requirement;
a target data rate; or a default receiver configuration.
   12. The method of any one of examples 1-10, further comprising sending, to the network node, an indication of the receiver configuration to be used for the radio procedure.
   13. The method of example 8, wherein determining one of a plurality of different receiver configurations supported by the UE for performing the radio procedure further comprises receiving the receiver configuration for the radio procedure from a network node (200, 500).
   14. The method of any one of examples 1-13, wherein the signal strength threshold is based on a mapping between a plurality of receiver configurations and the plurality of signal strength thresholds.
   15. The method of example 14, wherein the mapping is predefined.
   16. The method of example 14, wherein the mapping is configured by the network node.
   17. The method of any one of examples 14-16, wherein receiving the signal strength threshold for the radio procedure comprises receiving, from the network node, a reference to an entry in a mapping table, wherein the mapping table comprises a plurality of entries corresponding to the mapping between receiver configurations and signal strength thresholds.
   18. The method of example 17, further comprising receiving a mapping table from the network node, wherein the mapping table comprises a plurality of entries corresponding to the mapping between receiver configurations and signal strength thresholds.
   19. The method of any one of examples 1-18 wherein the obtaining the signal strength threshold comprises obtaining an absolute threshold.
   20. The method of any one of examples 1-18 wherein the obtaining the signal strength threshold comprises obtaining a relative threshold.
   21. An example method implemented by a network node in a wireless communication network, the method comprising:
determining a receiver configuration supported by a first UE for performing a radio procedure; and
sending, to the first UE, a signal strength threshold associated with the determined receiver configuration, wherein the signal strength threshold comprises one of a plurality of different signal strength thresholds for the radio procedure, each associated with a different receiver configuration.
   22. The method of example 21, wherein determining a receiver configuration supported by the UE for performing the radio procedure comprises determining a number of receivers used by the UE to perform the radio procedure.
   23. The method of example 21 or 22, wherein determining a receiver configuration supported by the UE for performing the radio procedure comprises determining whether the receiver can mitigate interference when performing the radio procedure.
   24. The method of any one of examples 21-23, wherein determining a receiver configuration supported by the UE for performing the radio procedure further comprises determining the receiver configuration based on one or more of:
a frequency band used by the UE to perform the radio procedure;
the radio conditions experienced by the UE;
the battery status of the UE;
a Quality of Service (QOS) requirement;
a target data rate; or
a default receiver configuration.
   25. The method of any one of examples 21-24, further comprising sending, to the UE, an indication of the receiver configuration to be used for the radio procedure.
   26. The method of example 21 or 22, wherein determining a receiver configuration supported by a first UE for performing a radio procedure comprises receiving an indication of the receiver configuration from the UE.
   27. The method of any one of examples 21-26, wherein sending a signal strength threshold to the UE comprises broadcasting the signal strength threshold in a broadcast message.
   28. The method of example 27, wherein the signal strength threshold is transmitted in a system information message.
   29. The method of any one of examples 21-26, wherein sending a signal strength threshold to the UE comprises sending the signal strength threshold to the UE in a dedicated message.
   30. The method of any one of examples 21-29, wherein the signal strength threshold is based on a mapping between a plurality of allowable receiver configurations and the plurality of signal strength thresholds.
   31. The method of example 30, wherein the mapping is predefined by an applicable standard.
   32. The method of example 31, wherein the mapping is configured by the network node.
   33. The method of any one of examples 30-32, wherein sending the signal strength threshold to the UE for the radio procedure comprises sending, to the UE, a reference to an entry in a mapping table, wherein the mapping table comprises a plurality of entries corresponding to the mapping between receiver configurations and signal strength thresholds.
   34. The method of example 32 or 33, further comprising sending, to the UE, a mapping table representing the mapping between receiver configurations and signal strength thresholds.
   35. The method of any one of examples 21-34, wherein the signal strength threshold comprises an absolute threshold.
   36. The method of any one of examples 21-34, wherein the signal strength threshold comprises a relative threshold.
   37. An example method implemented by a network node in a wireless communication network, the method comprising:
sending, to a first UE, a first signal strength threshold associated with a first receiver configuration supported by the first UE for performing a radio procedure; and
sending, to a second UE, a second signal strength threshold associated with a second receiver configuration for performing the radio procedure, wherein the second receiver configuration is different than the first receiver configuration, and wherein the second signal strength threshold is different than the first signal strength threshold.
   38. The method of example 37, wherein sending the first and second receiver configurations comprises:
determining the first receiver configuration;
sending the signal strength threshold associated with the first receiver configuration to the first UE;
determining the second receiver configuration; and
sending the signal strength threshold associated with the second receiver configuration to the second UE.
   39. The method of example 38, wherein determining the first and second receiver configurations comprises determining a number of receivers used by the first and second UEs respectively to perform the radio procedure.
   40. The method of example 38 or 39, wherein determining the first and second receiver configurations comprises determining a receiver used by the first UE can mitigate interference and a receiver used by the second UE cannot mitigate interference when performing the radio procedure.
   41. The method of any one of examples 38-40, wherein determining the first and second receiver configurations comprises determining the first and second receiver configurations based on one or more of:
a frequency bands used by the first and second UEs respectively to perform the radio procedure;
the radio conditions experienced by the first and second UEs;
the battery statuses of the first and second UEs;
a Quality of Service (QOS) requirements for the first and second UEs;
a target data rates for the first and second UEs; or a default receiver configuration.
   42. The method of any one of examples 38-41, further comprising sending, to each the first and second UEs, an indication of the receiver configuration to be used for the radio procedure.
   43. The method of example 38 or 39 wherein determining the first and second receiver configurations comprises receiving an indication of the receiver configuration from at least one of the first and second UEs.
   44. The method of any one of examples 37-43, wherein sending the first and second signal strength thresholds comprises broadcasting the first and second signal strength thresholds in a broadcast message.
   45. The method of example 44, wherein the first and second signal strength thresholds are broadcast in system information.
   46. The method of any one of examples 37-43, wherein sending the first and second signal strength thresholds comprises sending the first and second signal strength thresholds in dedicated messages.
   47. The method of any one of examples 37-46, wherein the first and second signal strength thresholds are based on a mapping between allowable receiver configurations and the plurality of signal strength thresholds.
   48. The method of example 47, wherein the mapping is predefined by an applicable standard.
   49. The method of example 47, wherein the mapping is configured by the network node.

50. The method of any one of examples 47-49, wherein sending the first and second signal strength thresholds for the radio procedure comprises sending, to the UE, a reference to an entry in a mapping table, wherein the mapping table comprises a plurality of entries corresponding to the mapping between receiver configurations and signal strength thresholds.

51. The method of example 49 or 50, further comprising sending, to the first and second UEs, a mapping table representing the mapping between receiver configurations and signal strength thresholds.
52. The method of any one of examples 37-51, wherein at least one of the first and second signal strength thresholds comprises an absolute threshold.
53. The method of any one of examples 37-51, wherein at least one of the first and second signal strength thresholds comprises a relative threshold.
54. An example user equipment (UE) in a wireless communication network, the UE being configured to:
obtain a signal strength threshold associated with a receiver configuration supported by the UE for performing a radio procedure, wherein the signal strength threshold comprises one of a plurality of different signal strength thresholds for the radio procedure, each associated with a different receiver configuration; and
perform the radio procedure using the signal strength threshold.
   55. The UE of example 54 further configured to perform the method of any one of examples 2-20.
   56. An example user equipment (UE) in a wireless communication network, the UE comprising:
communication circuitry configured to communicate with a network node in the wireless communication network; and
processing circuitry configured to:
   obtain a signal strength threshold associated with a receiver configuration supported by the UE for performing a radio procedure, wherein the signal strength threshold comprises one of a plurality of different signal strength thresholds for the radio procedure, each associated with a different receiver configuration; and
   perform the radio procedure using the signal strength threshold.
      57. The UE of example 56 further configured to perform the method of any one of examples 2-20.
      58. An example computer program comprising executable instructions that, when executed by a processing circuit in a user equipment in a wireless communication network, causes the user equipment to perform any one of the methods of examples 1-20
      59. An example carrier containing a computer program of example 58, wherein the carrier is one of an electronic signal, optical signal, radio signal, or computer readable storage medium.
      60. An example network node in a wireless communication network, the network node being configured to:
determine a receiver configuration supported by a first UE for performing a radio procedure; and
send), to the first UE, a signal strength threshold associated with the determined receiver configuration, wherein the signal strength threshold comprises one of a plurality of different signal strength thresholds for the radio procedure, each associated with a different receiver configuration.
   61. The network node of example 60 further configured to perform the method of any one of examples 22-36.
   62. An example network node in a wireless communication network, the network node comprising:
communication circuitry configured to communicate with a user equipment (UE) in the wireless communication network; and
processing circuitry configured to:
   determine a receiver configuration supported by a first UE for performing a radio procedure; and
   send), to the first UE, a signal strength threshold associated with the determined receiver configuration, wherein the signal strength threshold comprises one of a plurality of different signal strength thresholds for the radio procedure, each associated with a different receiver configuration.
      63. The network node of example 62 further configured to perform the method of any one of examples 22-36.
      64. An example computer program comprising executable instructions that, when executed by a processing circuit in a network node in a wireless communication network, causes the network node to perform any one of the methods of examples 21-36
      65. An example carrier containing a computer program of example 64, wherein the carrier is one of an electronic signal, optical signal, radio signal, or computer readable storage medium.
      66. An example network node in a wireless communication network, the network node being configured to:
send, to a first UE, a first signal strength threshold associated with a first receiver configuration supported by the first UE for performing a radio procedure; and
send, to a second UE, a second signal strength threshold associated with a second receiver configuration for performing the radio procedure, wherein the second receiver configuration is different than the first receiver configuration, and wherein the second signal strength threshold is different than the first signal strength threshold.
   67. The network node of example 66 further configured to perform the method of any one of examples 38-53.
   68. An example network node in a wireless communication network, the network node comprising:
communication circuitry configured to communicate with a user equipment (UE) in the wireless communication network; and
processing circuitry configured to:
   send, to a first UE, a first signal strength threshold associated with a first receiver configuration supported by the first UE for performing a radio procedure; and
   send, to a second UE, a second signal strength threshold associated with a second receiver configuration for performing the radio procedure, wherein the second receiver configuration is different than the first receiver configuration, and wherein the second signal strength threshold is different than the first signal strength threshold.
      69. The network node of example 68 further configured to perform the method of any one of examples 38-53.
      70. An example computer program comprising executable instructions that, when executed by a processing circuit in a network node in a wireless communication network, causes the network node to perform any one of the methods of examples 37-53.
      71. An example carrier containing a computer program of example 70, wherein the carrier is one of an electronic signal, optical signal, radio signal, or computer readable storage medium.
      72. An example wireless device comprising:
processing circuitry configured to perform the method of any of examples 1-20; and power supply circuitry configured to supply power to the wireless device.
   73. An example wireless device comprising:
processing circuitry and memory, the memory containing instructions executable by the processing circuitry whereby the wireless device is configured to perform the method of any of examples 1-20.
   74. An example user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of examples 1-20;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   75. An example base station comprising:
processing circuitry configured to perform the method of any of examples 21-53;
power supply circuitry configured to supply power to the wireless device.
   76. An example base station comprising:
processing circuitry and memory, the memory containing instructions executable by the processing circuitry whereby the base station is configured to perform the method of any of examples 37-53.
   77. An example communication system including a host computer comprising:
processing circuitry configured to provide user data; and a communication interface configured to forward the user data to a cellular network for transmission to a user equipment (UE),
wherein the cellular network comprises a base station having a radio interface and processing circuitry, the base station's processing circuitry configured to perform the method of any of examples 37-53.
   78. The communication system of the pervious example further including the base station.
   79. The communication system of the previous 2 examples, further including the UE, wherein the UE is configured to communicate with the base station.
   80. The communication system of the previous 3 examples, wherein:
the processing circuitry of the host computer is configured to execute a host application, thereby providing the user data; and
the UE comprises processing circuitry configured to execute a client application associated with the host application.
   81. An example method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs the method of any of examples 37-53.
   82. The method of the previous example, further comprising, at the base station, transmitting the user data.
   83. The method of the previous 2 examples, wherein the user data is provided at the host computer by executing a host application, the method further comprising, at the UE, executing a client application associated with the host application.
   84. An example user equipment (UE) configured to communicate with a base station, the UE comprising a radio interface and processing circuitry configured to perform any of the previous 3 examples.
   85. An example communication system including a host computer comprising:
processing circuitry configured to provide user data; and a communication interface configured to forward user data to a cellular network for transmission to a user equipment (UE),
wherein the UE comprises a radio interface and processing circuitry, the UE's components configured to perform the method of any of examples 1-20.
   86. The communication system of the previous example, wherein the cellular network further includes a base station configured to communicate with the UE.
E11. The communication system of the previous 2 examples, wherein:
the processing circuitry of the host computer is configured to execute a host application, thereby providing the user data; and
the UE's processing circuitry is configured to execute a client application associated with the host application.
   87. An example method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs the method of any of examples 1-20.
   88. The method of the previous example, further comprising at the UE, receiving the user data from the base station.
   89. An example communication system including a host computer comprising:
communication interface configured to receive user data originating from a transmission from a user equipment (UE) to a base station,
wherein the UE comprises a radio interface and processing circuitry, the UE's processing circuitry configured to perform the method of any of examples 1-20.
   90. The communication system of the previous example, further including the UE.
   91. The communication system of the previous 2 examples, further including the base station, wherein the base station comprises a radio interface configured to communicate with the UE and a communication interface configured to forward to the host computer the user data carried by a transmission from the UE to the base station.
   92. The communication system of the previous 3 examples, wherein:
the processing circuitry of the host computer is configured to execute a host application; and
the UE's processing circuitry is configured to execute a client application associated with the host application, thereby providing the user data.

93. The communication system of the previous 4 examples, wherein:
the processing circuitry of the host computer is configured to execute a host application, thereby providing request data; and
the UE's processing circuitry is configured to execute a client application associated with the host application, thereby providing the user data in response to the request data.
   94. An example method implemented in a communication system including a host computer, a base station and a user equipment (UE), the method comprising:
at the host computer, receiving user data transmitted to the base station from the UE, wherein the UE performs the method of any of examples 1-20.
   95. The method of the previous example, further comprising, at the UE, providing the user data to the base station.
   96. The method of the previous 2 examples, further comprising:
at the UE, executing a client application, thereby providing the user data to be transmitted; and
at the host computer, executing a host application associated with the client application.
   97. The method of the previous 3 examples, further comprising:
at the UE, executing a client application; and
at the UE, receiving input data to the client application, the input data being provided at the host computer by executing a host application associated with the client application,
wherein the user data to be transmitted is provided by the client application in response to the input data.
   98. An example communication system including a host computer comprising a communication interface configured to receive user data originating from a transmission from a user equipment (UE) to a base station, wherein the base station comprises a radio interface and processing circuitry, the base station's processing circuitry configured to perform the method of any of examples 37-53.
   99. The communication system of the previous example further including the base station.
   100. The communication system of the previous 2 examples, further including the UE, wherein the UE is configured to communicate with the base station.
   101. The communication system of the previous 3 examples, wherein:
the processing circuitry of the host computer is configured to execute a host application;
the UE is configured to execute a client application associated with the host application, thereby providing the user data to be received by the host computer.
   102. An example method implemented in a communication system including a host computer, a base station and a user equipment (UE), the method comprising:
at the host computer, receiving, from the base station, user data originating from a transmission which the base station has received from the UE, wherein the UE performs the method of any of examples 1-20.
   103. The method of the previous example, further comprising at the base station, receiving the user data from the UE.
   104. The method of the previous 2 examples, further comprising at the base station, initiating a transmission of the received user data to the host computer.

1. A method implemented by a user equipment (UE) in a wireless communication network, the method comprising:
receiving a first signal strength threshold value from a network node;
deriving a second signal strength threshold value associated with a receiver configuration supported by the UE for performing a radio procedure, the second signal strength threshold value being derived from the received first signal strength threshold value; and
performing the radio procedure using the second signal strength threshold value.

2. The method of claim 1, wherein the first signal strength threshold value is for a receiver configuration with two receive branches.

3. The method of claim 1, wherein the receiver configuration supported by the UE is a receiver configuration with one receive branch, and wherein the second signal strength threshold value is for a receiver configuration with one receive branch.

4. The method of claim 3, wherein the UE further supports a receiver configuration with two receive branches.

5. The method of claim 1, wherein the second signal strength threshold value is derived from the received first signal strength threshold value and an offset.

6. The method of claim 5, wherein the second signal strength threshold value is the sum of the received first signal strength threshold value and the offset.

7. The method of claim 1, wherein the radio procedure comprises one or more of selection of reference signal for random access transmission, selection between normal uplink carrier and supplementary uplink carrier, selection between 2-step random access and 4-step random access, selection between small data transmission and legacy transmission, and selection of resources for small data transmission.

8. The method of claim 1, wherein deriving a second signal strength threshold value associated with a receiver configuration supported by the UE comprises:
determining one of a plurality of different receiver configurations supported by the UE for performing the radio procedure; and
deriving a signal strength threshold value associated with the determined receiver configuration.

9. The method of claim 1, wherein the second signal strength threshold value is a relative threshold value.

10. (canceled)

11. (canceled)

12. The method of claim 1, wherein the first signal strength threshold value is received from the network node in one or both of a broadcast message and a system information message.

13. A method implemented by a network node in a wireless communication network, the method comprising:
determining a first receiver configuration supported by a UE for performing a radio procedure; and
sending, to the UE, a first signal strength threshold value associated with a second receiver configuration for the UE to derive, from the first signal strength threshold value, a second signal strength threshold value associated with the first receiver configuration.

14. The method of claim 13, wherein the second receiver configuration is a receiver configuration with two receive branches, and wherein the first signal strength threshold value is for a receiver configuration with two receive branches.

15. (canceled)

16. The method of claim 13, wherein the first receiver configuration supported by the UE is a receiver configuration with one receive branch, and wherein the second signal strength threshold value is for a receiver configuration with one receive branch.

17. The method of claim 16, wherein the second signal strength threshold value is derived from the first signal strength threshold value and an offset.

18. The method of claim 13, wherein the second signal strength threshold value is derived from the first signal strength threshold value and an offset.

19. The method of claim 18, wherein the second signal strength threshold value is the sum of the first signal strength threshold value and the offset.

20.-23. (canceled)

24. The method of claim 13, wherein sending a first signal strength threshold value to the UE comprises sending the first signal strength threshold value in a broadcast message and/or a system information message.

25. A user equipment in a wireless communication network, the UE being configured to:
receive a first signal strength threshold value from a network node;
derive a second signal strength threshold value associated with a receiver configuration supported by the UE for performing a radio procedure, the second signal strength threshold value being derived from the received first signal strength threshold value; and
perform the radio procedure using the second signal strength threshold value.

26. The UE of claim 25, wherein the first signal strength threshold value is for a receiver configuration with two receive branches.

27.-30. (canceled)

31. A network node in a wireless communication network, the network node being configured to:
determine a first receiver configuration supported by a UE for performing a radio procedure; and
send, to the UE, a first signal strength threshold value associated with a second receiver configuration for the UE to derive, from the first signal strength threshold value, a second signal strength threshold value associated with the first receiver configuration.

32. The network node of claim 31 further configured to perform the method, wherein the second receiver configuration is a receiver configuration with two receive branches, and wherein the first signal strength threshold value is for a receiver configuration with two receive branches.

33.-36. (canceled)
